(19) United States
(12) Patent Application Publication
(10) Pub. No.: US 2026/0064784 A1
(43) Pub. Date: Mar. 5, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: CHIHARU HIROHANA, Tokyo (JP)

(21) Appl. No.: 19/311,594

(22) Filed: Aug. 27, 2025

(30) Foreign Application Priority Data
Sep. 3, 2024 (JP) 2024-151537

(51) Int. Cl. G06F 16/9532; G06V 30/244

(52) U.S. Cl. CPC G06F 16/9532; G06V 30/2455

(57) ABSTRACT

A non-transitory computer-readable storage medium stores an application program which, when executed by one or more processors, causes an information processing apparatus to perform a control method, the control method including acquiring a document image including areas indicated by a plurality of handwritten portions on the document, acquiring an instruction sentence input by a user, identifying, from among the plurality of handwritten portions, an instruction portion that causes generative artificial intelligence (AI) to perform processing, converting the acquired instruction sentence input by the user into an instruction sentence enabling the generative AI to identify the instruction portion, and outputting the instruction sentence obtained by conversion and the acquired document image to the generative AI.

### BACKGROUND

### Field of the Technology

Aspects of the present disclosure generally relate to techniques for issuing an instruction to generative artificial intelligence (generative AI).

### DESCRIPTION OF THE RELATED ART

Recently, there has been a rapid spread of generative AI capable of automatically generating creative content for, for example, images, text, and sound. Along with this, various services using generative AI have been being provided.

For example, a service for performing reverse engineering with respect to a legacy program and a service that searches for an answer on the Internet in response to the user's inquiry using natural language are known.

Generative AI can also further take into account not only text data but also multimodal information such as image information. Specifically, for example, when the user inputs a photographic image showing “a flower bouquet with a certain single flower encircled (marked)” and the question sentence “what is the name of this flower?”, generative AI explains what kind of flower is contained in the encircled or marked area.

Moreover, an instance where the user performs manual writing (handwriting) in a printed document and the document with handwriting added thereto is computerized (scanned) is known. The contents of the added handwriting cover a wide variety of particulars, such as a supplemental explanation which the user has written to promote the user’s own understanding, a marking to an important portion, a marking to a portion about which the user researches and asks questions later, and points of doubt. There is a tendency in which the user performs handwriting at a plurality of portions and changes the style of handwriting depending on the contents of handwriting.

For example, the user marks an important portion with use of a yellow highlight pen and encircles, with a blue ballpoint pen, a portion that will be used by the user for later research or serves as a basis to later ask questions. There are various styles of handwriting depending on users. With regard to computerization of the document with handwriting added thereto, a service for creating a scan image in which only portions with handwriting added thereto have been emphasized or deleted (hereinafter referred to as a “handwritten portion emphasis service”) is known.

Moreover, Japanese Patent No. 7,048,275 discusses a technique which clips only an area which the user has highlighted with a marker or has encircled with a marker and performs optical character recognition (OCR) on the clipped area.

However, the handwritten portion emphasis service or the technique discussed in Japanese Patent No. 7,048,275 only directly recognizes a portion to which the user has added handwriting and is thus unable to be used to “cause generative AI to recognize an instruction portion”. Accordingly, the user is required to think about an instruction sentence for “identifying an instruction portion directed to generative AI” from among “contents which the user has handwritten” and thus has a heavy burden of inputting an instruction.

### SUMMARY OF THE DISCLOSURE

According to an aspect of the present disclosure, a non-transitory computer-readable storage medium storing an application program which, when executed by one or more processors, causes an information processing apparatus to perform a control method, the control method including acquiring a document image including areas indicated by a plurality of handwritten portions on the document, acquiring an instruction sentence input by a user, identifying, from among the plurality of handwritten portions, an instruction portion that causes generative artificial intelligence (AI) to perform processing, converting the acquired instruction sentence, which has been input by the user, into an instruction sentence enabling the generative AI to identify the instruction portion, and outputting the instruction sentence obtained by conversion and the acquired document image to the generative AI.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration example of an information processing system.

FIGS. 2A, 2B, and 2C are diagrams illustrating configuration examples of the respective apparatuses constituting the information processing system.

FIG. 3 is a sequence diagram of the information processing system.

FIG. 4 is a flowchart of processing starting with issuing an instruction to generative artificial intelligence (AI) and ending with outputting an answer acquired from the generative AI in the information processing system in each of first to fifth exemplary embodiments.

FIGS. 5A, 5B, 5C, and 5D are diagrams illustrating specific examples of document images, each of which is input to the information processing system, and answers, each of which is acquired from the generative AI.

FIGS. 6A and 6B are diagrams illustrating examples of screens which are used for the user to perform manipulation and confirmation in the information processing system in each of the first to fifth exemplary embodiments.

FIGS. 7A and 7B are diagrams illustrating examples of screens which are used for the user to perform manipulation and confirmation in the information processing system in the second exemplary embodiment.

FIG. 8 is a flowchart of processing starting with issuing an instruction to generative AI and ending with outputting an answer acquired from the generative AI in the information processing system in the second exemplary embodiment.

FIG. 9 is a diagram illustrating an example of a screen which the user manipulates in the information processing system in the third exemplary embodiment.

FIGS. 10A and 10B are diagrams illustrating examples of screens each of which the user manipulates in the information processing system in the fourth exemplary embodiment.

FIG. 11 is a flowchart of processing starting with issuing an instruction to generative AI and ending with outputting an answer acquired from the generative AI in the information processing system in the fifth exemplary embodiment.

FIG. 12 is a diagram illustrating an example of a screen which is used for the user to perform manipulation and confirmation in the information processing system in the fifth exemplary embodiment.

FIG. 13 is a flowchart of processing starting with issuing an instruction to generative AI and ending with outputting an answer acquired from the generative AI in an information processing system in a sixth exemplary embodiment.

FIGS. 14A and 14B are diagrams illustrating examples of screens which are used for the user to perform manipulation and confirmation in the information processing system in the sixth to ninth exemplary embodiments.

FIGS. 15A and 15B are diagrams illustrating examples of screens which are used for the user to perform manipulation and confirmation in the information processing system in the seventh exemplary embodiment.

FIG. 16 is a flowchart of processing starting with issuing an instruction to generative AI and ending with outputting an answer acquired from the generative AI in the information processing system in the seventh exemplary embodiment.

FIG. 17 is a diagram illustrating an example of a screen which the user manipulates in the information processing system in the eighth exemplary embodiment.

FIGS. 18A and 18B are diagrams illustrating examples of screens each of which the user manipulates in the information processing system in the ninth exemplary embodiment.

### DESCRIPTION OF THE EMBODIMENTS

Various exemplary embodiments, features, and aspects of the disclosure will be described in detail below with reference to the drawings. Furthermore, constituent elements described in the following exemplary embodiments are illustrated as examples, and should not be construed to limit the scope of the present disclosure. For example, each component constituting the present disclosure can be substituted by an optional constituent element capable of fulfilling a similar function. Moreover, an optional constituent object can be added to the illustrated constituent elements.

Furthermore, each of the first to fifth exemplary embodiments illustrates an example of solving the above-mentioned issue by performing conversion of an instruction sentence. Then, each of the sixth to ninth exemplary embodiments illustrates an example of solving the above-mentioned issue by performing conversion of an image.

### Information Processing System

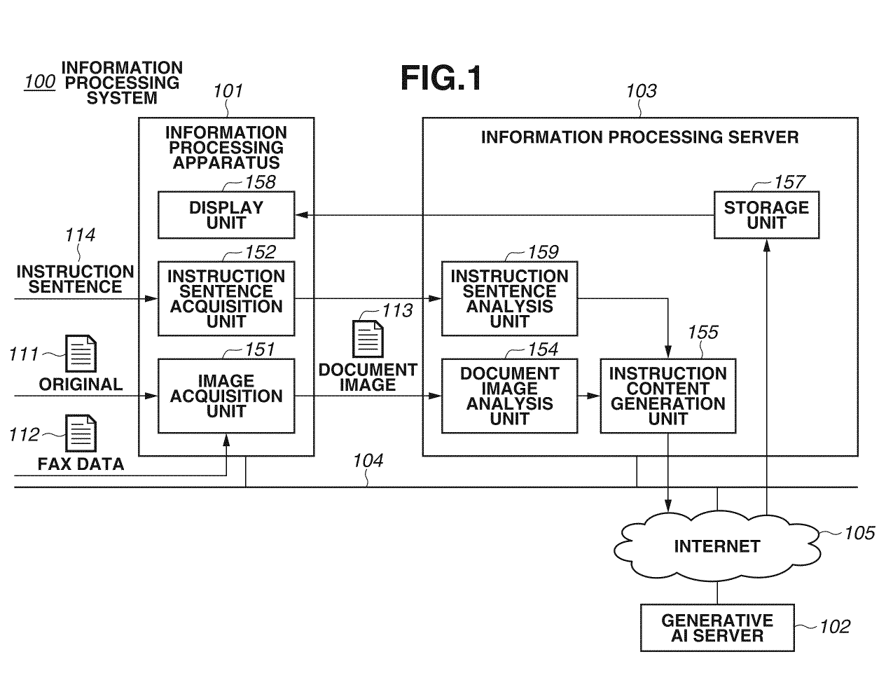

FIG. 1 is a block diagram illustrating a configuration example of an information processing system 100 according to a first exemplary embodiment of the present disclosure.

As illustrated in FIG. 1, the information processing system 100 includes an information processing apparatus 101, a generative artificial intelligence (AI) server 102, and an information processing server 103. For example, the information processing apparatus 101 and the information processing server 103 are connected to each other via a network 104.

Here, instead of a configuration in which a single information processing apparatus 101 and a single information processing server 103 are connected to the network 104, a configuration in which a plurality of information processing apparatuses 101 and a plurality of information processing servers 103 are connected to the network 104 can be employed. For example, a configuration in which the information processing server 103 is configured with a first server apparatus having a high-speed arithmetic resource and a second server apparatus having a large amount of storage and the first server apparatus and the second server apparatus are connected to each other via the network 104 can be employed.

The network 104 is connected to the Internet 105, externally provided, via a router (not illustrated). The generative AI server 102 is connected to the information processing apparatus 101 and the information processing server 103 via the Internet 105 and the network 104 in such a way as to be able to communicate with the information processing apparatus 101 and the information processing server 103.

The information processing apparatus 101 is implemented by, for example, a multifunction peripheral (MFP), which includes a plurality of functions such as print, scan, and facsimile (FAX), a personal computer, a smartphone, or a tablet terminal. The information processing apparatus 101 includes, as functional units thereof, an image acquisition unit 151, an instruction sentence acquisition unit 152, and a display unit 158.

The image acquisition unit 151 generates a document image 113 by, for example, optically reading an original 111 printed on a recording medium such as paper and performing predetermined scan image processing on the read original 111 and then transmits the document image 113 to the information processing server 103. Moreover, the image acquisition unit 151 generates a document image 113 by, for example, receiving FAX data 112 transmitted from a FAX transmitter (not illustrated) and performing predetermined FAX image processing on the received FAX data 112 and then transmits the document image 113 to the information processing server 103.

Furthermore, the information processing apparatus 101 can be a configuration implemented by, besides the above-mentioned MFP including scan and FAX functions, for example, a personal computer (PC).

Specifically, for example, the information processing apparatus 101 can be configured to transmit, to the information processing server 103, a document image 113 in, for example, Portable Document Format (PDF) or Joint Photographic Experts Group (JPEG) generated by a document creation application running on a PC serving as the information processing apparatus 101.

Moreover, the information processing apparatus 101 can be a smartphone or a tablet terminal. In this case, the information processing apparatus 101 can be configured to use an image captured by a camera attached thereto.

The instruction sentence acquisition unit 152 transmits, to the information processing server 103, for example, an instruction sentence 114 which the user has input via the display unit 158 described below. At this time, the instruction sentence 114 which the user has input can be a sentence previously prepared by an engineer or the user, can be a sentence obtained by the user or the system modifying or performing addition writing to the previously prepared sentence, or can be a sentence which the user or the system has directly input from ground zero. Each of the image acquisition unit 151 and the instruction sentence acquisition unit 152 is an example of an acquisition unit according to an aspect of the present disclosure.

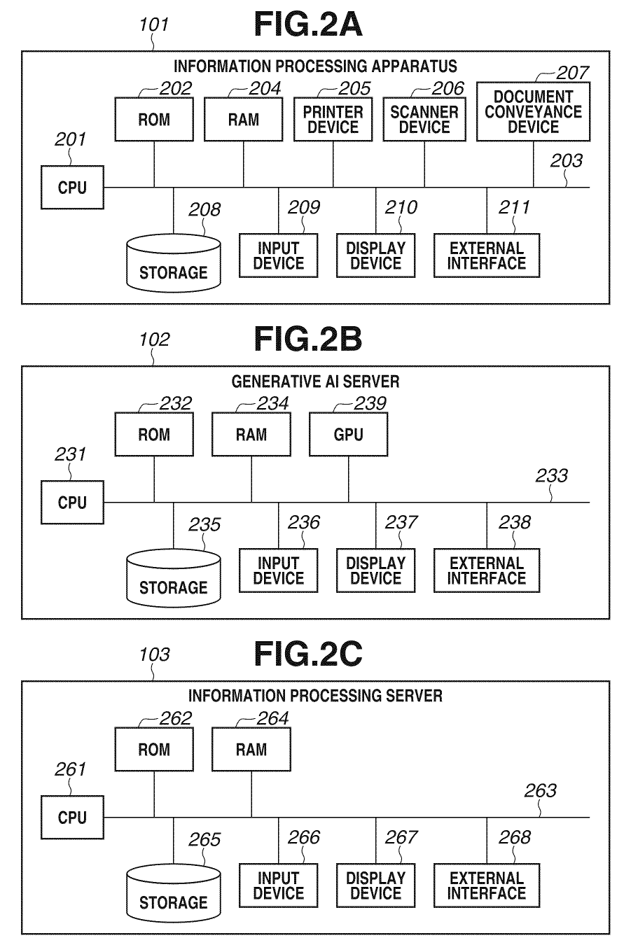

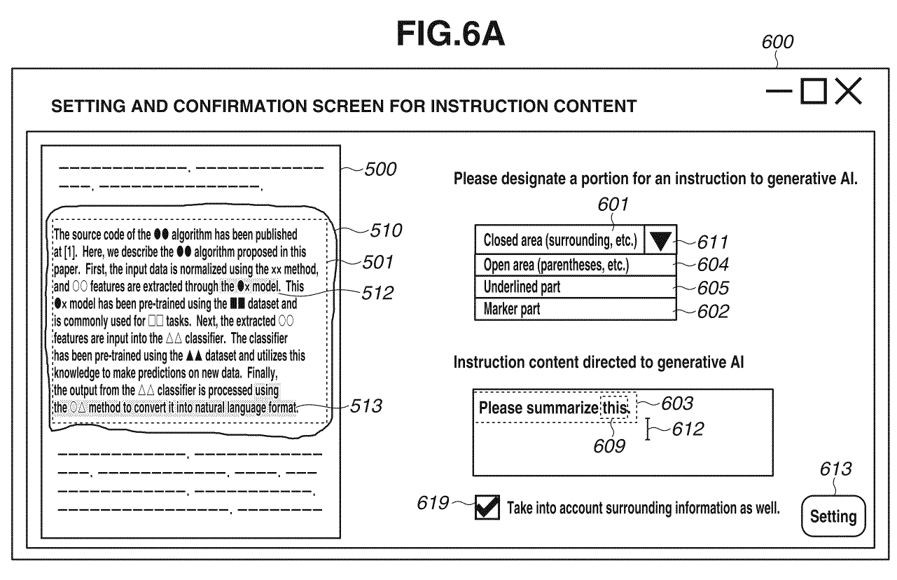

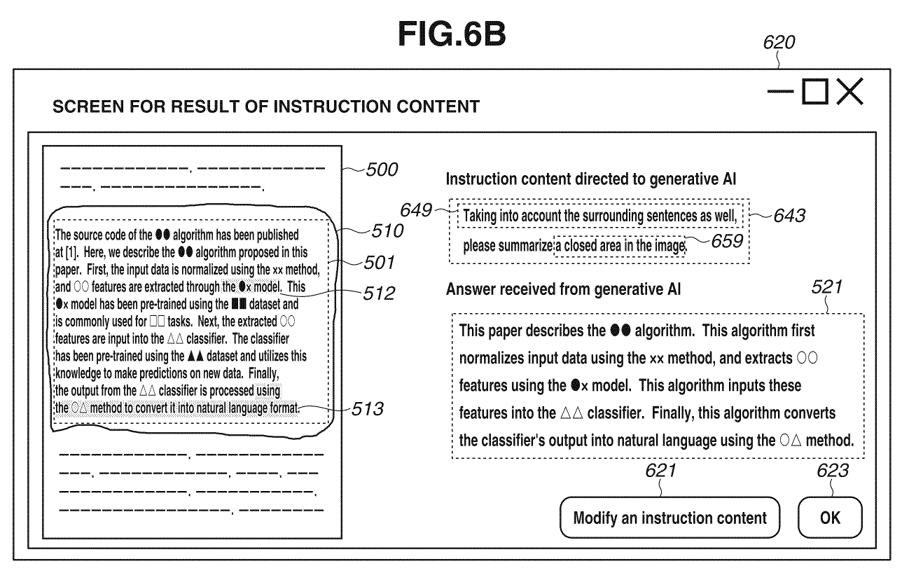

The display unit 158 displays information received from the information processing server 103 on a display of a display device 210 (see FIG. 2A). The display unit 158 displays, for example, a setting and confirmation screen 600 for instruction content (see FIG. 6A) described below. Furthermore, the display unit 158 can display the information on a display of, instead of the display device 210 (see FIG. 2A), a display device 267 (see FIG. 2C). Moreover, the display unit 158 can display the information on a display unit (not illustrated) of, for example, a PC or a mobile terminal connected to the information processing apparatus 101 via the Internet 105 and the network 104.

The generative AI server 102 is a server which a business operator which provides a generative AI service manages. The generative AI server 102 is a server which is accessed by an application programming interface (API) and outputs an answer result responsive to an instruction sentence and an instruction image received from the information processing server 103.

Here, the generative AI server 102 can be a server which is available in combination with a plug-in for implementing an additional function which a business operator which provides a service utilizing a generative AI service has developed. Moreover, the generative AI server 102 can exist as a server connected in series to the information processing system 100 via the network 104 or can be configured to exist on another system of the same vendor as that for the information processing system 100.

Furthermore, the functions of the generative AI server 102 can be configured to exist within the information processing server 103 or some functions or devices of the generative AI server 102 can be configured to exist within the information processing server 103.

The information processing server 103 functions as a document image analysis unit 154, an instruction sentence analysis unit 159, an instruction content generation unit 155, and a storage unit 157. The information processing server 103 has the role of receiving, as an input, the document image 113 and transmits, to the information processing apparatus 101, a result obtained by processing the document image 113 via the generative AI server 102.

First, the document image analysis unit 154 performs processing for recognizing a handwritten portion with respect to the document image 113 received from information processing apparatus 101 and thus detects the handwritten portion. The document image analysis unit 154 is an example of an identification unit according to an aspect of the present disclosure. The method of recognizing a handwritten portion uses a known technique. The known technique includes, for example, a technique which classifies a document image into a typed area, a handwritten area, and a blank area using the idea of semantic segmentation.

The classifier with a known technique applied thereto can be a classifier which is accessible from an eternal unit via an API or can exist as a learning device (not illustrated) provided via the network 104. Moreover, the document image analysis unit 154 can be configured to perform, in addition to detection of a handwritten portion, optical character recognition (OCR) on the document image 113. The OCR can be directed to the entire document image 113 or can be directed to each of the typed area and the handwritten area included in the document image 113.

Next, with regard to the instruction sentence 114 received from the information processing apparatus 101, the instruction sentence analysis unit 159 detects a description indicating to where in the document image 113 an instruction included in the instruction sentence 114 is directed. Specifically, for example, the instruction sentence analysis unit 159 detects a word or words possibly indicating a part, an area, or a portion in the document image 113 with use of a known natural language processing technique.

Examples of the known natural language processing technique include a technique which detects or identifies an instruction term such as “here” by reference resolution and extracts a specific keyword such as “area” or “portion”.

Next, the instruction content generation unit 155 generates, based on the handwritten portion in the document image 113 and the instruction sentence 114, an instruction sentence (not illustrated) available for identifying an instruction portion directed to generative AI. The instruction sentence available for identifying an instruction portion directed to generative AI is, for example, text obtained by replacing an instruction term included in the instruction sentence 114 with a specific notation such as a surrounding line. The instruction content generation unit 155 fixes, as an instruction content, the instruction sentence available for identifying an instruction portion directed to generative AI and the document image 113. The instruction content generation unit 155 is an example of a conversion unit according to an aspect of the present disclosure.

Furthermore, the instruction content generation unit 155 can also be configured to generate an instruction sentence (not illustrated) to which an OCR result acquired by the document image analysis unit 154 has been additionally written and fix the generated instruction sentence and the document image 113 as an instruction content.

Next, the information processing server 103 transmits, to the generative AI server 102, the instruction content generated and fixed by the instruction content generation unit 155. Additionally, the information processing server 103 receives, from the generative AI server 102, an answer result responsive to the instruction content generated and fixed by the instruction content generation unit 155, and then stores the received answer result in the storage unit 157.

The network 104 is a network implemented by, for example, a local area network (LAN) or wide area network (WAN), and is a communication unit which connects the information processing apparatus 101, the generative AI server 102, and the information processing server 103 to each other and allows data to be transmitted and received between such apparatuses. Furthermore, the network 104 can be a network using wired connection and can be a network using wireless connection.

### Apparatus Configurations

FIGS. 2A, 2B, and 2C are diagrams illustrating hardware configuration examples of the information processing apparatus 101, the generative AI server 102, and the information processing server 103 included in the information processing system 100.

FIG. 2A is a diagram illustrating a hardware configuration of the information processing apparatus 101. In the present specification, an example in which a multifunction peripheral / printer (MFP) is employed as the information processing apparatus 101 is described.

As illustrated in FIG. 2A, the information processing apparatus 101 includes a central processing unit (CPU) 201, a read-only memory (ROM) 202, a random access memory (RAM) 204, a printer device 205, a scanner device 206, a document conveyance device 207, and a storage 208. Additionally, the information processing apparatus 101 includes an input device 209, a display device 210, and an external interface 211. The respective units of the information processing apparatus 101 are connected to each other via a data bus 203.

The CPU 201 is a control unit for controlling the entire operation in the information processing apparatus 101. The CPU 201 starts up a system for the information processing apparatus 101 by executing a boot program stored in the ROM 202 and implements the functions, such as print, scan, and FAX, of the information processing apparatus 101 by executing a control program stored in the storage 208.

The ROM 202 is a storage unit which is implemented by a non-volatile memory, and stores the boot program to be used for starting up the information processing apparatus 101.

A data bus 203 is a communication unit which is used to transmit and receive data between the respective devices constituting the information processing apparatus 101.

The RAM 204 is a storage unit which is implemented by a volatile memory, and is used as a work memory for the CPU 201 to execute the control program.

The printer device 205 is an image output device, and prints a document image on a recording medium such as paper and outputs the recording medium with the document image recorded thereon. The scanner device 206 is an image input device, and optically reads a recording medium, such as paper, with, for example, characters or graphics printed thereon. Data obtained by the scanner device 206 performing optical reading is acquired as a document image.

The document conveyance device 207 is implemented by, for example, an automatic document feeder (ADF), and detects documents serving as originals placed on a document placing plate and conveys the detected documents one by one to the scanner device 206.

The storage 208 is a storage unit which is implemented by, for example, a hard disk drive (HDD), and stores the above-mentioned control program and document image.

The input device 209 is an operation unit which is implemented by, for example, a touch panel or hardware keys, and receives and accepts an operation input from the user who uses the information processing apparatus 101. The display device 210 is a display unit which is implemented by, for example, a liquid crystal display, and displays and outputs, for example, a setting screen for the information processing apparatus 101 to the user. For example, as mentioned above with regard to the display unit 158 (see FIG. 1), the display device 210 displays a setting and confirmation screen 600 for instruction content (see FIG. 6A) described below.

The external interface 211 is an interface which interconnects the information processing apparatus 101 and the network 104, and transmits a document image to the information processing server 103 and transmits a document image and an instruction sentence (prompt) to the generative AI server 102. The external interface 211 is an example of an output unit according to an aspect of the present disclosure.

FIG. 2B is a diagram illustrating a hardware configuration of the generative AI server 102. As illustrated in FIG. 2B, the generative AI server 102 includes a CPU 231, a ROM 232, a RAM 234, a storage 235, an input device 236, a display device 237, an external interface 238, and a graphics processing unit (GPU) 239. The respective units of the generative AI server 102 are connected to each other via a data bus 233.

The CPU 231 is a control unit which controls the entire operation of the generative AI server 102. The CPU 231 starts up a system for the generative AI server 102 by executing a boot program stored in the ROM 232 and executes a control program stored in the storage 235.

Furthermore, the control program to be executed here uses a large language model (LLM) capable of allowing inputting of multimodal data about at least images and text. Then, the control program to be executed here outputs a result obtained by performing conversion according to an instruction sentence (prompt) given with text.

The ROM 232 is a storage unit which is implemented by a non-volatile memory, and stores the boot program to be used for starting up the generative AI server 102.

A data bus 233 is a communication unit which is used to transmit and receive data between the respective devices constituting the generative AI server 102.

The RAM 234 is a storage unit which is implemented by a volatile memory, and is used as a work memory for the CPU 231 to execute the control program.

The storage 235 is a storage unit which is implemented by, for example, a hard disk drive (HDD), and stores, for example, the above-mentioned control program, large language model, document image, and instruction sentence (prompt).

The input device 236 is an operation unit which is implemented by, for example, a mouse and a keyboard, and receives and accepts an operation input to the generative AI server 102 from the user who uses the generative AI server 102.

The display device 237 is a display unit which is implemented by, for example, a liquid crystal display, and displays and outputs a setting screen for the generative AI server 102 to the user who uses the generative AI server 102.

The external interface 238 is an interface which interconnects the generative AI server 102 and the network 104, and receives a document image and an instruction sentence (prompt) from the information processing server 103. Moreover, the external interface 238 transmits an output result obtained by the large language model to the information processing server 103.

The GPU 239 is a computation unit configured with an image processing processor. The GPU 239 performs, for example, computation for performing conversion using the large language model on the input data about images or text according to the control command given from the CPU 231.

FIG. 2C is a diagram illustrating a hardware configuration of the information processing server 103. As illustrated in FIG. 2C, the information processing server 103 includes a CPU 261, a ROM 262, a RAM 264, a storage 265, an input device 266, a display device 267, and an external interface 268, and the respective devices of the information processing server 103 are interconnected via a data bus 263.

The CPU 261 is a control unit for controlling the entire operation of the information processing server 103. The CPU 261 starts up a system for the information processing server 103 by executing a boot program stored in the ROM 262 and implements various functions, such as displaying of a document image and inputting of an instruction to generative AI, by executing a control program stored in the storage 265.

The ROM 262 is a storage unit which is implemented by a non-volatile memory, and stores the boot program to be used for starting up the information processing server 103. A data bus 263 is a communication unit which is used to transmit and receive data between the respective devices constituting the information processing server 103. The RAM 264 is a storage unit which is implemented by a volatile memory, and is used as a work memory for the CPU 261 to execute the control program.

The storage 265 is a storage unit which is implemented by, for example, a hard disk drive (HDD), and stores the above-mentioned control program and document image.

The input device 266 is an operation unit which is implemented by, for example, a mouse and a keyboard, and receives and accepts an operation input to the information processing server 103 from the user who uses the information processing server 103 or the engineer who controls the information processing server 103.

The display device 267 is a display unit which is implemented by, for example, a liquid crystal display. The display device 267 displays and outputs, for example, a setting screen for the information processing server 103 or an input screen for the generative AI server 102 to the user who uses the information processing server 103 or the engineer who controls the information processing server 103. For example, as mentioned above with regard to the display unit 158 (see FIG. 1), instead of the display device 210, the display device 267 can display a setting and confirmation screen 600 for instruction content (see FIG. 6A) described below.

The external interface 268 is an interface which interconnects the information processing server 103 and the network 104, and receives a document image from the information processing apparatus 101 and transmits an instruction sentence (prompt) to the generative AI server 102.

### Use Sequence

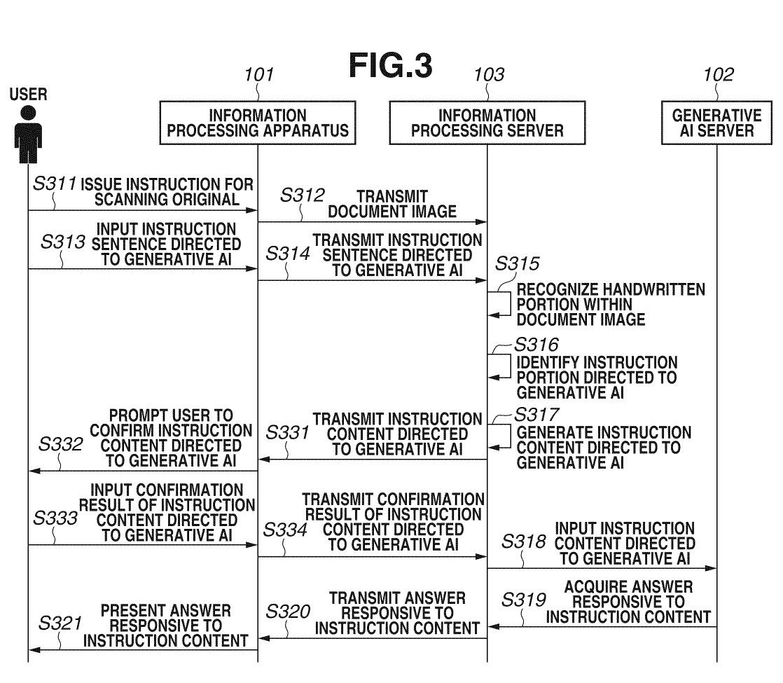

FIG. 3 is a diagram illustrating a sequence which is performed in the information processing system 100.

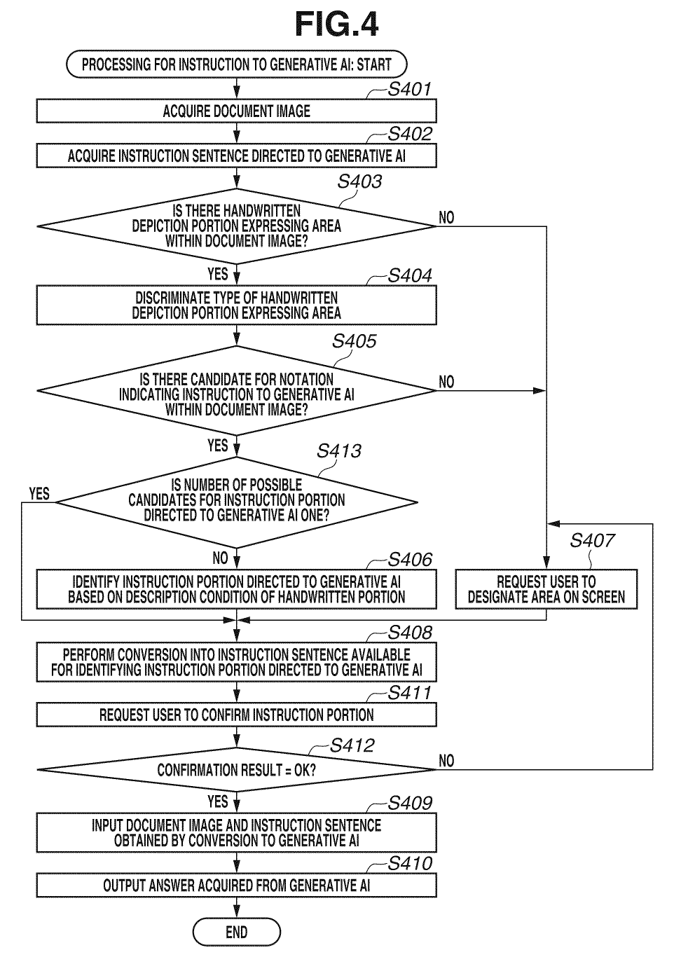

FIG. 3 is a sequence diagram illustrating the flow of processing starting with inputting of an instruction to the generative AI server 102 and ending with outputting of an answer responsive to the instruction with use of a document image 113 and an instruction sentence 114 which have been acquired in the information processing apparatus 101. Furthermore, the details of a method of performing processing starting with inputting of an instruction to generative AI and ending with outputting of an answer responsive to the instruction, which is performed by the information processing server 103 in the flow of sequence illustrated in FIG. 3 are described below with reference to FIG. 4.

In step S311, the user who uses the information processing system 100 places an original, such as a paper document, on the document conveyance device 207 of the information processing apparatus 101, presses a scan execution button using the input device 209, and thus issues an instruction for scanning of an original.

In step S312, the information processing apparatus 101 transmits a document image 113 obtained by scanning the original 111 to the information processing server 103.

In step S313, the user who uses the information processing system 100 inputs, to the information processing apparatus 101 via the input device 209, an instruction sentence 114 for issuing an instruction to generative AI with respect to the document image 113. The instruction sentence 114 corresponds to, for example, text 603 illustrated in FIG. 6A. Here, the instruction sentence 114 can be text which has preliminarily been prepared by the engineer or user, can be text obtained by the user or system performing modification or additional writing to the preliminarily prepared text, or can be text which the user or system has directly input from ground zero.

In step S314, the information processing apparatus 101 transmits, to the information processing server 103, the instruction sentence 114 input by the user who uses the information processing system 100.

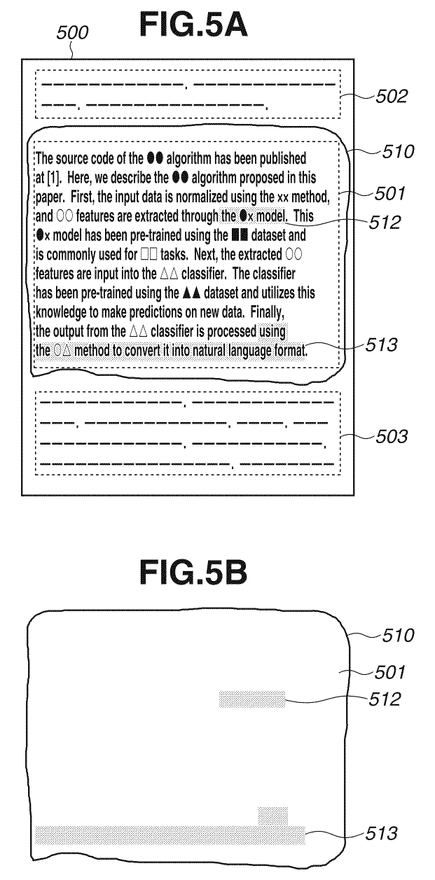

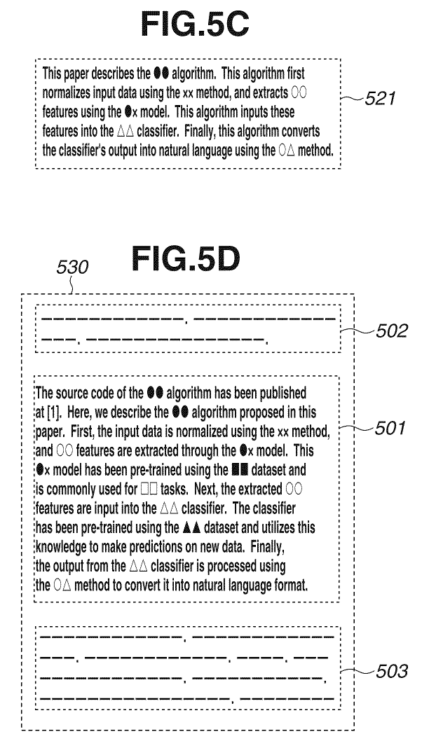

In step S315, the information processing server 103 recognizes a handwritten portion from within the document image 113 received in step S312. The handwritten portion refers to the whole of things written by hand within the original 111. After that, the information processing server 103 extracts a handwritten depiction portion representing an area from within the recognized handwritten portion. These portions are described with reference to FIGS. 5A and 5B.

FIG. 5A illustrates a specific example of the document image 113, and FIG. 5B illustrates only a handwritten portion extracted from within a document image 500 illustrated in FIG. 5A.

The handwritten portion refers to a surrounding line 510, which surrounds text 501, a marker area 512, and a marker area 513. Moreover, the handwritten depiction portion representing an area refers to the surrounding line 510, the marker area 512, and the marker area 513. Thus, the handwritten depiction portion representing an area is a handwritten portion enabling clearly understanding from where to where the portion is referring to.

The handwritten depiction portion representing an area can include, besides a portion surrounded by a line and a portion highlighted by a marker, for example, a portion indicated by parentheses and an underlined portion.

Furthermore, although not being handled in the first exemplary embodiment, handwritten text is categorized into a handwritten portion that is not the handwritten depiction portion representing an area.

In step S316, with regard to the instruction sentence 114 received in step S314, the information processing server 103 detects a description indicating where in the document image 113 the instruction is directed to. After that, the information processing server 103 collates the detected description with the handwritten depiction portion representing an area extracted in step S315. With this collation, the information processing server 103 identifies an instruction portion directed to generative AI from the handwritten depiction portion representing an area extracted in step S315.

In step S317, the information processing server 103 converts the instruction sentence 114 received in step S314 into text available for identifying the handwritten portion identified in step S316 as the instruction portion directed to generative AI. The information processing server 103 fixes the instruction sentence obtained by conversion and the document image 113 received in step S312 as an instruction content directed to generative AI. Furthermore, the information processing server 103 can use, as the instruction content directed to generative AI, instead of the instruction sentence obtained by conversion, an instruction sentence in which text obtained by performing OCR on the document image 113 and the instruction sentence obtained by conversion have been reflected.

In step S331, the information processing server 103 transmits, to the information processing apparatus 101, the instruction content directed to generative AI fixed in step S317.

In step S332, the information processing apparatus 101 presents the instruction content received in step S331 to the user who uses the information processing system 100. With this presentation, the information processing apparatus 101 prompts the user who uses the information processing system 100 to confirm whether the instruction content is what the user has intended.

In step S333, the user who uses the information processing system 100 inputs a confirmation result of the instruction content presented in step S332.

In step S334, the information processing apparatus 101 transmits, to the information processing server 103, the confirmation result input in step S333. In step S318, based on the confirmation result received in step S334, the information processing server 103 transmits the instruction content received in step S314 to the generative AI server 102.

In step S319, the generative AI server 102 returns, to the information processing server 103, an answer responsive to the instruction content received in step S318.

In step S320, the information processing server 103 transmits the answer received in step S319 to the information processing apparatus 101. Furthermore, instead of transmitting the answer to the information processing apparatus 101, the information processing server 103 can present the answer on the display device 267. In this case, the information processing system 100 omits a processing operation in step S321 described below. In step S321, the information processing apparatus 101 presents, via the display device 210, the answer received in step S320 to the user who uses the information processing system 100.

### Processing for Instruction to Generative AI

FIG. 4 is a flowchart illustrating the flow of processing starting with issuing an instruction to the generative AI server 102 and ending with outputting an answer acquired from the generative AI server 102, which has been described with reference to FIG. 3. A series of processing operations illustrated in the flowchart of FIG. 4 is assumed to be performed by the CPU 261 of the information processing server 103 loading program code stored in the ROM 262 or the storage 265 onto the RAM 264 and executing the program code.

In step S401, the CPU 261 acquires a document image obtained by the information processing apparatus 101 reading an original such as a paper document. In step S402, the CPU 261 acquires an instruction sentence directed to generative AI obtained by the information processing apparatus 101 accepting an input from the user. Steps S401 and S402 are an example of “acquiring” according to an aspect of the present disclosure.

The instruction sentence corresponds to, for example, text 603 illustrated in FIG. 6A. The text 603 is an instruction sentence for issuing an instruction for summarizing the text 501 illustrated in FIG. 5A. Examples of instructions other than the instruction for summarization include instructions for translation into another language, conversion into image information, supplementary information search for, for example, back data or meaning, and correction of erroneous description. Moreover, in step S402, the CPU 261 has the function of determining whether, with regard to the acquired instruction sentence, a word or words possibly indicating a part, an area, or a portion in the document image.

For example, the CPU 261 performs such determination by known natural language processing using, for example, “surrounded area” or “here”.

In step S403, the CPU 261 recognizes a handwritten portion with use of known technique from within the document image acquired in step S401. Moreover, the CPU 261 determines whether, within the recognized handwritten portion, there is a handwritten depiction portion representing an area.

Furthermore, as explained above in step S315, the handwritten portion refers to the whole of things written by hand within an original, and the handwritten depiction portion representing an area is a handwritten portion enabling clearly understanding from where to where the portion is referring to.

Then, if it is determined that there is a handwritten depiction portion representing an area (YES in step S403), the CPU 261 advances the processing to step S404. If it is determined that there is no handwritten depiction portion representing an area (NO in step S403), the CPU 261 advances the processing to step S407.

Furthermore, examples of the known technique of recognizing a handwritten portion include a classifier for clustering printed portions and handwritten portions and an extractor for extracting pixels of a handwritten portion in an image. Furthermore, examples of the printed portion include texts 501 to 503 in the document image 500 illustrated in FIG. 5A. Examples of the handwritten portion include a surrounding line 510, a marker area 512, and a marker area 513 in the document image 500.

In using these known techniques, the information processing system 100 can be prepared as a learning apparatus or can use an apparatus existing in an external server via an API. Moreover, the CPU 261 can be configured to, without recognizing a handwritten portion, directly recognize a handwritten depiction portion representing an area.

In step S404, the CPU 261 discriminates, with regard to the handwritten depiction portion representing an area recognized in step S403, the type of the shape of the handwritten depiction portion. Step S404 is an example of “discriminating” in an aspect of the present disclosure. This is described with reference to FIG. 6A. FIG. 6A illustrates an example of a screen which is used for the user to perform setting and confirmation of an instruction content.

As explained above in step S315, the handwritten depiction portion representing an area includes the surrounding line 510 and the marker areas 512 and 513. The types of shapes of the handwritten depiction portion are preliminarily determined by the engineer or user, and correspond to, for example, shapes shown in respective list boxes 601, 602, 604, and 605.

The CPU 261 performs clustering about to which of the list boxes 601, 602, 604, and 605 the handwritten depiction portion representing an area is applicable. As a result of clustering, the surrounding line 510 is allocated to a cluster for “closed area” in the list box 601, and the marker area 512 and the marker area 513 are allocated to a cluster for “marker part” in the list box 602.

Furthermore, the clustering method uses a known technique. The cluster processing can be implemented on the information processing system 100 or can use a method existing in an external server via an API.

Moreover, in the first exemplary embodiment, discrimination as to where in the document image the instruction sentence designates is performed by processing (not illustrated) for determining a relationship between a handwritten depiction and a document image. Besides this, the discrimination can be performed based on other factors such as colors or line thicknesses or a combination of those. Examples of the discrimination result include a color marker area, double underline, and thick dashed line.

In step S405, the CPU 261 determines whether there is a candidate for a notation indicating “a portion which the instruction sentence acquired in step S402 designates” from among the types of shapes serving as the result of discrimination performed in step S404. If it is determined that there is a candidate for a notation indicating “a portion which the instruction sentence designates” from among the types of shapes serving as the result of discrimination performed in step S404 (YES in step S405), the CPU 261 advances the processing to step S413.

If it is determined that there is no candidate for a notation indicating “a portion which the instruction sentence designates” from among the types of shapes serving as the result of discrimination performed in step S404 (NO in step S405), the CPU 261 advances the processing to step S407.

Furthermore, the portion which the instruction sentence designates indicates which area in the document image acquired in step S401 the instruction sentence designates. Moreover, for example, in a case where the “portion which the instruction sentence designates” is not confined in the instruction sentence, such as “Please perform summarization” instead of “Please summarize this”, the CPU 261 advances the processing to step S407. Moreover, for example, in a case where the “portion which the instruction sentence designates” is actually present in the instruction sentence but is not able to be detected, such as the case where, with regard to an instruction sentence “Please summarize a surrounded portion”, the surrounded portion has not been able to be detected from within the image, the CPU 261 advances the processing to step S407.

Here, determination as to whether there is a candidate for a notation indicating “a portion which the instruction sentence designates” is specifically described with reference to FIG. 6A. FIG. 6A illustrates an example of a screen which is used for the user to perform setting and confirmation of an instruction content.

Text 603 is an instruction sentence directed to generative AI for the document image 500, which the user has input with use of a cursor 612. The term “here” (text 609) in the text 603 is an instruction term indicating a specific portion in the document image, and is assumed to, as the user’s intention, point to text in a closed area defined by the surrounding line 510 written on the document image. Thus, the instruction portion directed to generative AI is assumed to be the whole of a text area surrounded by a surrounding line such as the surrounding line 510 in the document image.

The candidate for a notation indicating “a portion which the instruction sentence designates” is a handwritten depiction portion representing an area, to which the term “here” (text 609) in the text 603 is likely to point. Furthermore, in a case where there is a plurality of handwritten depiction portions each representing an area having the same shape, the CPU 261 collectively handles the plurality of handwritten depiction portions as a single candidate.

As explained above in step S404, the handwritten depiction portion representing an area includes two types of shapes such as the closed area (surrounding line 510) and the marker parts (marker areas 512 and 513).

Thus, the specific candidate for a notation indicating “a portion which the instruction sentence designates” includes two candidates, i.e., the surrounding line (510) and the marker areas (512 and 513). Therefore, the CPU 261 determines that there is a candidate for a notation indicating “a portion which the instruction sentence designates”.

Furthermore, although not been described in the first exemplary embodiment, for example, in a case where, in step S404, the handwritten depiction portion representing an area has been discriminated into a cluster which is unclear about from where to where the handwritten depiction portion points to, such as writing of an asterisk or arrow, the term “here” (text 609) in the text 603 is not clearly known. Therefore, in this case, the CPU 261 determines that there is no candidate for a notation indicating “a portion which the instruction sentence designates”.

In step S413, the CPU 261 determines whether the number of candidates for a notation indicating “a portion which the instruction sentence designates” determined in step S405 is one. If it is determined that the number of candidates for a notation indicating “a portion which the instruction sentence designates” is one (YES in step S413), the CPU 261 advances the processing to step S408. If it is determined that the number of candidates for a notation indicating “a portion which the instruction sentence designates” is plural (NO in step S413), the CPU 261 advances the processing to step S406.

Here, determination as to whether the number of candidates for a notation indicating “a portion which the instruction sentence designates” is one is described with reference to FIG. 6A. As explained above in step S405, the candidate for a notation indicating “a portion which the instruction sentence 603 designates” includes two candidates, i.e., the surrounding line (510) and the marker areas (512 and 513). Therefore, the CPU 261 determines that there is a plurality of candidates for a notation indicating “a portion which the instruction sentence designates”.

Furthermore, for example, in a case where the candidate for a notation indicating “a portion which the instruction sentence designates” includes only the marker areas (512 and 513), which have the same marker shape, the CPU 261, therefore, deems the marker areas (512 and 513) as one type of marker area and thus determines that the number of candidates for a notation indicating “a portion which the instruction sentence designates” is one. Moreover, the CPU 261 can integrate step S405 and step S413 into one determination. Moreover, in a case where the number of candidates for a notation indicating “a portion which the instruction sentence designates” is one (YES in step S413), the CPU 261 can omit step S408 and then advances the processing to step S411.

In step S406, the CPU 261 presents, to the user, the candidate for a notation indicating the instruction portion directed to generative AI detected at the time of determination in step S405, and accepts selection from the candidate by the user (an example of “accepting”). The CPU 261 identifies an instruction portion based on the notation indicating the instruction portion directed to generative AI selected by the user (an example of “identifying”). Selection by the user is described below in the chapter <Interface with User concerning Instruction to Generative AI> with reference to FIGS. 6A and 6B.

In step S407, the CPU 261 accepts, from the user, inputting of an instruction portion directed to generative AI. After that, the CPU 261 advances the processing to step S408. As the method of inputting the instruction portion, for example, the instruction portion can be input freehand onto an image, can be input using, for example, a preliminarily prepared rectangle or circle, or can be input by trailing the user’s finger on text in the instruction portion.

Moreover, the user can designate the entire document image as an instruction portion directed to generative AI. The method of designating the entire document image includes, for example, a method of arranging a radio button signifying the entire document on a screen for accepting inputting of an instruction portion and a method of surrounding the entire document image with a line.

In step S408, the CPU 261 converts the instruction sentence acquired in step S402 into an instruction sentence enabling clearly knowing the instruction portion identified in step S406 or step S407 (an example of “converting”). Conversion of the instruction sentence is described with reference to FIG. 6A.

As explained above in step S405, the candidate for a notation indicating an instruction portion in the document image 500 includes two candidates, i.e., the surrounding line (510) and the marker areas (512 and 513). Here, suppose that the user has selected “closed area” in the list box 601. Thus, suppose that the user has selected the surrounding line (510) as a notation indicating an instruction portion. At this time, the CPU 261 generates an instruction sentence obtained by substituting text 609 in the instruction sentence 603 with text 659 indicating “closed area” in the list box 601.

After that, the CPU 261 additionally writes text 649 indicating that a check box 619 for taking into account surrounding information has been checked, and thus generates an instruction sentence 643. Furthermore, the surrounding information is a group of pieces of information present in front of, behind, to the left of, and to the right of the instruction portion, and is auxiliary information for preventing the instruction portion from being understood in a different way. For example, in a case where a part of one paragraph is an instruction portion, the surrounding information refers to a portion obtained by excluding the instruction portion from the entirety of such paragraph.

Furthermore, the CPU 261 can generate an instruction sentence without text 649 being additionally written thereto, can generate an instruction sentence with text 649 being additionally written thereto without preparing the check box 619, or can additionally write text 649 to an instruction sentence at timing to cause generative AI to perform regeneration.

In step S411, the CPU 261 presents the document image acquired in step S401 and the instruction sentence obtained by conversion in step S408 to the user who uses the information processing system 100, and prompts the user to confirm whether those are in accord with the user’s intention. Examples of the method for prompting the user for confirmation include a method of presenting the document image and the instruction sentence on a confirmation screen to the user who uses the information processing system 100 and causing the user to, if everything is in order, press an “OK” button and, if correction is needed, press a “correction” button.

In step S412, the CPU 261 determines, with use of the confirmation result acquired in step S411, whether the document image acquired in step S401 and the instruction sentence obtained by conversion in step S408 are in accord with the intention of the user who uses the information processing system 100. If it is determined that those are in accord with the intention of the user who uses the information processing system 100 (YES in step S412), the CPU 261 advances the processing to step S409. If it is determined that those are not in accord with the intention of the user who uses the information processing system 100 (NO in step S412), the CPU 261 advances the processing to step S407.

For example, when having detected pressing of the “OK” button in step S411, the CPU 261 determines that those are in accord with the intention of the user who uses the information processing system 100. Moreover, when having detected pressing of the “correction” button in step S411, the CPU 261 determines that those are not in accord with the intention of the user who uses the information processing system 100.

In step S409, the CPU 261 fixes the document image acquired in step S401 and the instruction sentence obtained by conversion in step S408 as an instruction content directed to generative AI. After that, the CPU 261 transmits the fixed instruction content to the generative AI server 102 (an example of “outputting”). Furthermore, the CPU 261 can use, as an instruction content directed to generative AI, instead of the instruction sentence acquired in step S408, an instruction sentence obtained by adding modification to the instruction sentence acquired in step S408.

Here, the instruction sentence obtained by adding modification is described with reference to FIG. 5D. FIG. 5D is a diagram illustrating an OCR result 530 obtained from the document image 500 illustrated in FIG. 5A. Moreover, the instruction sentence obtained by conversion in step S408 is assumed to be text 643 illustrated in FIG. 6B.

At this time, the instruction sentence obtained by adding modification is text configured as, for example, a two-chapter structure including chapters indicating “instruction” and “OCR result”, in which text 643 accompanied by a preface “Taking into account the OCR result,” is inserted into the chapter indicating “instruction” and the OCR result 530 is inserted into the chapter indicating “OCR result”. This may cause the appearance of an advantageous effect in which the processing performance in generative AI is made better by adding a result obtained by performing OCR than the case of inputting a document image to generative AI and causing the generative AI to process the document image.

In step S410, the CPU 261 acquires an answer received from the generative AI server 102 responsive to the instruction content input in step S409. After that, the CPU 261 presents the acquired answer to the user. An example of the presentation to the user is described with reference to FIG. 5C and FIG. 6B.

FIG. 5C is a diagram illustrating a result obtained by summarizing the text 501. FIG. 6B illustrates an example of a screen which is used for the user to confirm a result obtained by issuing an instruction to generative AI.

The CPU 261 displays, on a screen 620, a summarization result 521 as well as the document image 500 and the instruction sentence 643 which has been input to generative AI. At this time, the CPU 261 can add modification to the text (summarization result) 521 to change that into an easily comprehensible form for the user. Moreover, the CPU 261 can display, instead of the instruction sentence 643, an instruction sentence obtained by modifying the instruction sentence 643 and inputting the modified instruction sentence 643 to generative AI, or can display only the summarization result 521. While, in the first exemplary embodiment, the CPU 261 performs displaying on a summarization result screen, the CPU 261 can be configured to be able to perform outputting in the form of, for example, metadata or comment regarding a document image.

### Interface with User concerning Instruction to Generative AI

An interface with the user concerning an instruction to generative AI is described with reference to FIGS. 6A and 6B. FIG. 6A is a diagram illustrating an example of a screen which is used for the user to perform manipulation and confirmation, on the display device 210 included in the information processing system 100.

First, the case of fixing an instruction portion directed to generative AI is described. FIG. 6A illustrates an example of a screen which is used for the user to set and confirm an instruction content. The screen 600 is configured with a document image 500 which the user has input, list boxes 601, 602, 604, and 605 for selecting an instruction portion, a pull-down button 611, an instruction sentence 603, a cursor 612 for inputting an instruction sentence, and a “setting” button 613 for fixing the instruction content. Moreover, the screen 600 additionally includes a check box 619 for indicating whether to take into account not only the instruction portion directed to generative AI but also surrounding information.

As explained above in step S406, the information processing system 100 presents, to the user, the surrounding line (510) and the marker areas (512 and 513) as the candidate for a notation indicating the instruction portion directed to generative AI. Furthermore, in the first exemplary embodiment, an option indicating the surrounding line (510) corresponds to “closed area” in the list box 601, and an option indicating the marker areas (512 and 513) corresponds to “marker part” in the list box 602.

Upon detecting pressing of the pull-down button 611 by the user, the information processing system 100 display the list boxes 602, 604, and 605, which are options not currently selected. Furthermore, the options can be not list boxes but other form options such as radio buttons as long as they are able to fulfill the function of selection.

Moreover, as explained above in step S402, the information processing system 100 accepts inputting of an instruction sentence 603 directed to generative AI from the user. In the first exemplary embodiment, the method of inputting an instruction sentence is implemented by the cursor 612, but can be the form of performing selection or editing with respect to instruction sentences which the engineer or user has preliminarily prepared, can be the form of editing a model form instruction sentence, or can be the form of performing selection or modifying with respect to a past input history. Besides, the information processing system 100 can preliminarily store an instruction portion and an instruction sentence as the history of an instruction content directed to generative AI and, when having recognized a similar handwritten portion, display the past instruction sentence as a recommendation.

Moreover, upon detecting pressing of the setting button 613 by the user, the information processing system 100 performs processing operations as described in step S401 to step S408 and thus fixes an instruction portion directed to generative AI and an instruction sentence. At this time, when detecting a selection operation by the user on the list boxes 601, 602, 604, and 605 and the check box 619, the information processing system 100 can interactively perform conversion of the instruction sentence and substitute the instruction sentence 603 with the instruction sentence 643.

Next, the case of confirming an answer received from generative AI responsive to the instruction content is described. FIG. 6B illustrates an example of a screen which is used for the user to confirm a result obtained by issuing an instruction to generative AI. The screen 620 is configured with a document image 500, an instruction sentence 643 directed to generative AI, an answer result 521 received from generative AI, a “modify an instruction content” button 621, and an “OK” button 623.

As explained above in step S410, the information processing system 100 presents an answer received from generative AI to the user. Upon detecting pressing of the “modify an instruction content” button 621 by the user, the information processing system 100 causes the screen 620 to transition to the screen 600. Moreover, upon detecting pressing of the “OK” button 623 by the user, the information processing system 100 deems that the answer received from generative AI has been completed, closes the screen 620, and thus ends the system.

As described above, according to the first exemplary embodiment, the information processing system 100 converts an instruction sentence which the user has input into an instruction sentence available for identifying an instruction portion directed to generative AI. Accordingly, it is possible to, while reducing the user’s effort of thinking of an instruction sentence, issue an instruction which is in accord with the user’s intention.

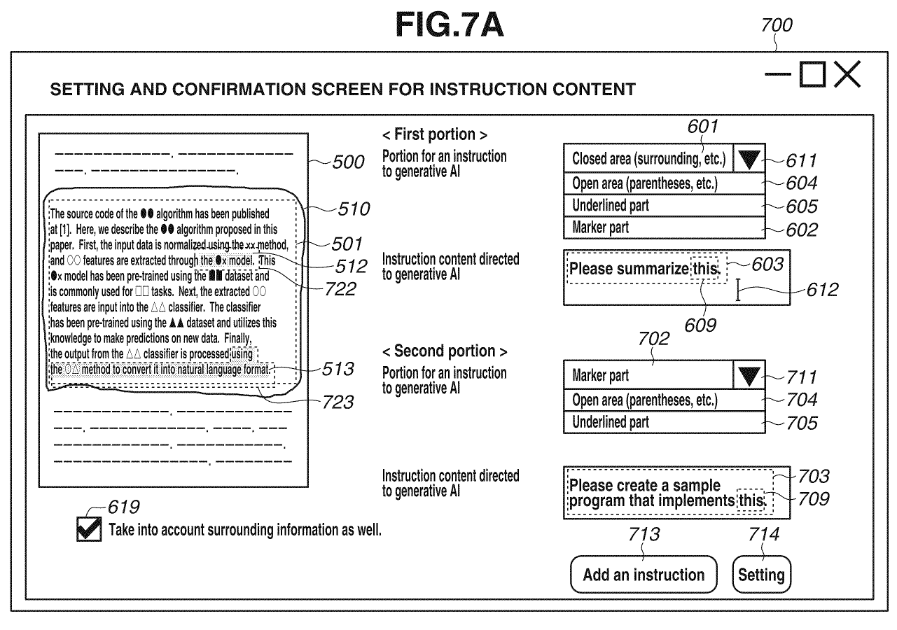

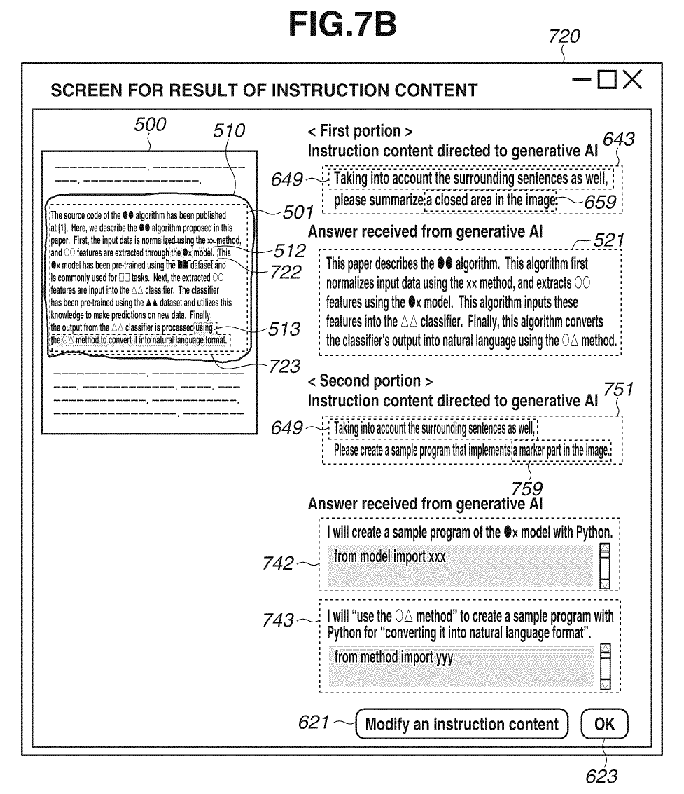

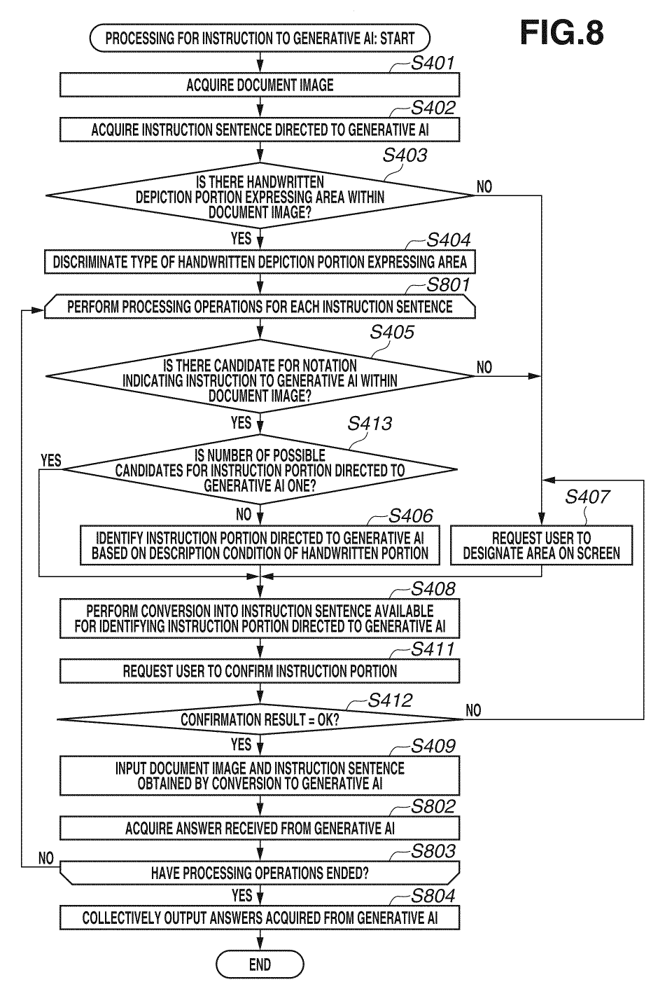

In the first exemplary embodiment, in a case where there is only one type of notation indicating an instruction to generative AI, the information processing system 100 issues an instruction to generative AI. On the other hand, in a second exemplary embodiment, in a case where there is a plurality of types of notation indicating an instruction to generative AI, the information processing system 100 switches between instructions to generative AI with respect to the respective types of notation. The second exemplary embodiment is described mainly with FIGS. 7A and 7B substituted for FIGS. 6A and 6B used in the first exemplary embodiment and FIG. 8 substituted for FIG. 4 used in the first exemplary embodiment. In the second exemplary embodiment, points other than these are similar to those in the first exemplary embodiment and are, therefore, omitted from description here.

### Processing for Instruction to Generative AI

FIG. 8 is a flowchart illustrating the flow of processing starting with issuing an instruction to the generative AI server 102 and ending with outputting an answer acquired from the generative AI server 102 in the second exemplary embodiment. Among processing operations illustrated in the flowchart of FIG. 8, processing operations with the same step numbers as those in the flowchart of FIG. 4 are basically similar to those in the first exemplary embodiment and are, therefore, omitted from description here. However, among the processing operations with the same step numbers as those in in the flowchart of FIG. 4, with regard to processing operations having different portions from those in the first exemplary embodiment, only such differences are described.

In step S402, the CPU 261 acquires an instruction sentence directed to generative AI obtained by the information processing apparatus 101 accepting an input from the user. At this time, the CPU 261 acquires one instruction sentence per one type of notation indicating an instruction to generative AI. This is described with reference to FIG. 7A. FIG. 7A illustrates an example of a screen which is used for the user to perform setting and confirmation of an instruction content.

In the second exemplary embodiment, there exist two instruction sentences (text 603 and text 703). The text 603 is an instruction sentence directed to generative AI which the user has input via the cursor 612 with respect to the text 501 (text in “closed area” in the list box 601) included in the document image 500. The text 703 is an instruction sentence directed to generative AI which the user has input via the cursor 612 with respect to texts 722 and 723 (texts in “marker part” in the list box 602) included in the document image 500. FIGS. 7A and 7B are described below in detail in chapter “Interface with User concerning Instruction to Generative AI”.

In step S801, the CPU 261 performs processing operations in step S405 to step S802 for each instruction sentence acquired in step S402. For example, in the example illustrated in FIG. 7A, since, as explained above in step S402, there exist two instruction sentences (text 603 and text 703), the CPU 261 performs processing operations in step S405 to step S802 for each of the text 603 and the text 703. Thus, the CPU 261 performs processing operations in step S405 to step S802 two times.

In step S802, the CPU 261 acquires an answer received from the generative AI server 102 responsive to the instruction content input in step S409.

In step S803, the CPU 261 determines whether the processing operations have ended with respect to all of the instruction sentences acquired in step S402, and then repeats the processing operations in step S405 to step S802 until it is determined that the processing operations have ended with respect to all of the instruction sentences.

In step S804, the CPU 261 collects the answers acquired in step S802 for the respective instruction sentences and presents the collected answers to the user. An example of the presentation to the user is described with reference to FIG. 7B. FIG. 7B illustrates an example of a screen which is used for the user to confirm a result obtained by issuing an instruction to generative AI.

First, the CPU 261 displays, on a screen 720, a document image 500 which is in common between two instruction sentences (643 and 751). Then, the CPU 261 displays, as the first answer, an answer result 521 as well as the instruction sentence 643 input to generative AI, on the screen 720.

Moreover, the CPU 261 displays, as the second answer, answer results 742 and 743 as well as the instruction sentence 751 input to generative AI, on the screen 720. At this time, the CPU 261 can add modification to the answer result 521 and the answer results 742 and 743 to change those into an easily comprehensible form for the user. Moreover, the CPU 261 can display, instead of the instruction sentence 643 and the instruction sentence 751, instruction sentences obtained by modifying the instruction sentence 643 and the instruction sentence 751 and inputting the modified instruction sentences 643 and 751 to generative AI, or can display only the answer result 521 and the answer results 742 and 743.

While, in the second exemplary embodiment, the CPU 261 performs displaying on an answer result screen, the CPU 261 can be configured to be able to perform outputting in the form of, for example, metadata or comment regarding a document image, or can be configured to be able to perform outputting in the form of, for example, paper from the information processing apparatus 101. Moreover, for each instruction sentence, the CPU 261 can modify the document image 500 into an image enabling visually understanding for which portion an instruction has been issued and display the image obtained by modification for each instruction sentence.

Furthermore, while, in the second exemplary embodiment, the CPU 261 performs processing operations in step S405 to step S802 for each instruction sentence, the CPU 261 can collectively perform such processing operations at one time. Conversely, the CPU 261 can perform a processing operation in step S804 for each instruction sentence or each instruction portion.

### Interface with User concerning Instruction to Generative AI

FIGS. 7A is a diagram illustrating an example of a screen which is used for the user to perform manipulation and confirmation, on the display device 210 included in the information processing system 100 in the second exemplary embodiment. Among portions illustrated in FIG. 7A, portions with the same reference numerals as those in FIG. 6A are similar to those in the first exemplary embodiment and are, therefore, omitted from description here.

First, the case of fixing an instruction portion directed to generative AI is described. FIG. 7A illustrates an example of a screen which is used for the user to set and confirm an instruction content in the second exemplary embodiment. The screen 700 includes, with respect to each of two types of notation indicating an instruction to generative AI within the document image 500, list boxes and a pull-down button for selecting the type of notation indicating an instruction to generative AI and an input field for an instruction sentence. The first portion is similar to that in the first exemplary embodiment and is, therefore, omitted from description, and, in the following description, only the second portion is described.

All of the types of shape to be discriminated in step S404 are displayed in the list boxes 601, 602, 604, and 605 as options for notations indicating an instruction to generative AI. In the first portion, “closed area” in the list box 601 is selected by the user as a notation indicating an instruction to generative AI. Therefore, in options for notations indicating an instruction to generative AI in the second portion, the information processing system 100 presents, to the user, list boxes 702, 704, and 705 with “closed area” removed.

Upon detecting pressing of the pull-down button 711 by the user, the information processing system 100 displays the list boxes 704 and 705, which are options not yet selected. Furthermore, as also explained above in the first exemplary embodiment, the options can be not list boxes but other form options such as radio buttons as long as they are able to fulfill the function of selection. Moreover, as explained above in step S402, the information processing system 100 accepts inputting of an instruction sentence 703 directed to generative AI from the user. The method of inputting an instruction sentence is similar to that in the first exemplary embodiment and is, therefore, omitted from description.

Moreover, upon detecting pressing of a button 713 by the user, the information processing system 100 adds new notations indicating an instruction to generative AI and a new input field for an instruction sentence. Furthermore, the upper limit of the number of sets of notations and an input field able to be added is the number of types of shape to be discriminated in step S404.

Upon detecting pressing of the setting button 714 by the user, the information processing system 100 performs processing operations as described in step S401 to step S408 and thus fixes an instruction portion directed to generative AI and an instruction sentence. At this time, when detecting a selection operation by the user on the list boxes 601, 602, 604, and 605 and the check box 619, the information processing system 100 can interactively perform conversion of the instruction sentence and substitute the instruction sentence 603 with the instruction sentence 643.

Finally, upon detecting pressing of the setting button 714 by the user, the information processing system 100 performs processing operations as described in step S401 to step S408 and thus acquires instruction portions and instruction sentences with respect to all of the notations each indicating an instruction to generative AI. In the second exemplary embodiment, since the notation indicating an instruction to generative AI in the first portion is “closed area” in the list box 601, the information processing system 100 acquires an instruction portion in the first portion as a text area 501 surrounded by the surrounding line 510 and acquires an instruction sentence in the first portion as text 603.

Moreover, since the notation indicating an instruction to generative AI in the second portion is the list box 702, the information processing system 100 acquires instruction portions in the second portion as text areas 722 and 723 of the marker areas 512 and 513 and acquires an instruction sentence in the second portion as text 703. After that, as explained above in step S408, based on the fixed instruction portions and instruction sentences, the information processing system 100 converts each of the instruction sentences into an instruction sentence enabling clearly knowing an instruction portion directed to generative AI.

Thus, in the second exemplary embodiment, the instruction sentence obtained by conversion in the first portion becomes text 643 illustrated in FIG. 7B obtained by reflecting “closed area” in the list box 601 and information about the check box 619 in the text 603. Moreover, the instruction sentence obtained by conversion in the second portion becomes text 751 illustrated in FIG. 7B obtained by reflecting “marker part” in the list box 702 and information about the check box 619 in the text 703.

Next, the case of confirming an answer received from generative AI responsive to the instruction content is described. FIG. 7B illustrates an example of a screen which is used for the user to confirm a result obtained by issuing an instruction to generative AI in the second exemplary embodiment. The screen 720 includes, in addition to elements included in the screen 620 illustrated in FIG. 6B, an instruction sentence 751 in the second portion directed to generative AI and answer results 742 and 743 received from generative AI regarding the second portion.

As explained above in step S804, the information processing system 100 presents, to the user, an answer received from generative AI for each of notations indicating the respective instructions to generative AI. At this time, upon presenting the document image 500 used for an instruction to generative AI, the information processing system 100 lumps together instruction sentences (643 and 751) and answers received from generative AI (521, 742, and 743) and presents those for each of notations indicating the respective instructions to generative AI.

Furthermore, when having detected a notation indicating an instruction portion or a user’s selection regarding an instruction portion, the information processing system 100 can take the form of displaying the corresponding instruction sentence and answer. For example, after detecting selection of the surrounding line 510 or the marker areas 512 and 513 by the user, the information processing system 100 can display an instruction sentence directed to generative AI and an answer corresponding to the detected handwritten depiction portion representing an area. At this time, the information processing system 100 can alter the notation indicating an instruction to generative AI and thus clearly identify such notation by text.

As described above, according to the second exemplary embodiment, even in a case where there is a plurality of types of notation indicating an instruction to generative AI, it is possible to issue an instruction which is in accord with the user’s intention, by switching between instruction contents directed to generative AI for the respective types of notation.

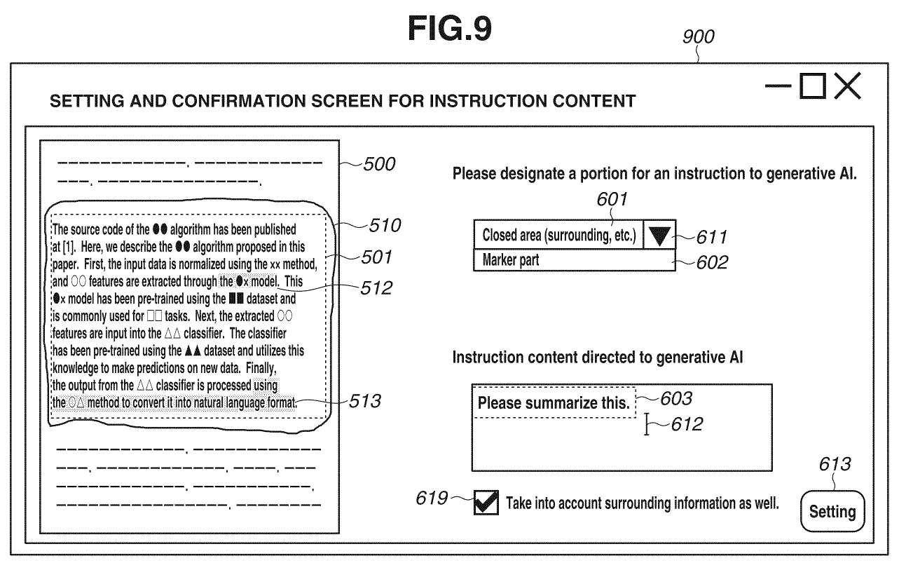

In the above-described first exemplary embodiment, in a case where the user who uses the information processing system 100 performs setting of an instruction content, the information processing system 100 presents, as options of candidates for an instruction portion directed to generative AI, all of the types of shape to be discriminated in step S404 illustrated in FIG. 4. On the other hand, in a third exemplary embodiment, the information processing system 100 presents, as the options, only types of shape included in a document image acquired in step S401 illustrated in FIG. 4. The third exemplary embodiment is described with FIG. 9 substituted for FIG. 6A used in the first exemplary embodiment. In the third exemplary embodiment, points other than these are similar to those in the first exemplary embodiment and are, therefore, omitted from description here.

### Interface with User concerning Instruction to Generative AI

FIG. 9 is a diagram illustrating an example of a screen which is used for the user to perform setting and confirmation of an instruction content, on the display device 210 included in the information processing system 100 in the third exemplary embodiment. Among portions illustrated in FIG. 9, portions with the same reference numerals as those in FIG. 6A are similar to those in the first exemplary embodiment and are, therefore, omitted from description here.

The screen 900 is a screen in which options of a notation indicating an instruction portion are restricted to list boxes 601 and 602, which are notations existing in a document image, with respect to the screen 600. As explained above in step S404 illustrated in FIG. 4, with regard to the document image 500, the surrounding line 510 is allocated to a cluster for “closed area” in the list box 601, and the marker area 512 and the marker area 513 are allocated to a cluster for “marker part” in the list box 602.

Thus, with respect to the document image 500, among clusters which the engineer or user has preliminarily prepared, only two clusters are applicable. Therefore, the information processing system 100 presents, to the user who uses the information processing system 100, “closed area” in the list box 601 and “marker part” in the list box 602 as options of a notation indicating an instruction portion directed to generative AI.

Furthermore, in the third exemplary embodiment, when indicating options of a notation indicating an instruction portion directed to generative AI, the information processing system 100 displays the options by text, but can display the options by an image of handwritten depiction portion representing an area. For example, instead of text “closed area (surrounding, etc.)” in the list box 601, the information processing system 100 depicts an image obtained by reducing and conceptualizing the surrounding line 510.

Moreover, in the third exemplary embodiment, the user who uses the information processing system 100 issues an instruction for an instruction portion directed to generative AI by selecting or pressing the list boxes 601 and 602. However, for example, the user who uses the information processing system 100 can issue an instruction for an instruction portion directed to generative AI by selecting or pressing handwritten depiction portions each representing an area (the surrounding line 510 and the marker areas 512 and 513) on the document image 500 in the screen 900.

Upon detecting selection or pressing of handwritten depiction portions each representing an area by the user, the information processing system 100 reflects the selection result in the list boxes 601 and 602. Thus, for example, upon detecting pressing of the surrounding line 510, the information processing system 100 selects the list box 601. Moreover, upon detecting selection or pressing of handwritten depiction portions each representing an area by the user, the information processing system 100 can perform intensified displaying, by, for example, highlighting, of the selected or pressed depiction portions.

As described above, according to the third exemplary embodiment, the information processing system 100 is able to present, to the user, only portions included in the received document image as options of instruction portions directed to generative AI. This enables reducing the user’s trouble in selecting an instruction portion.

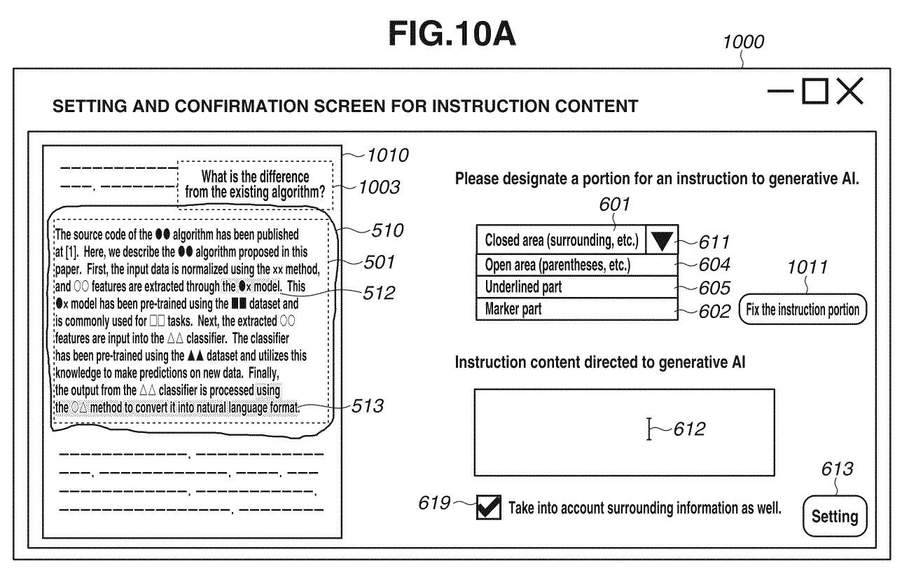

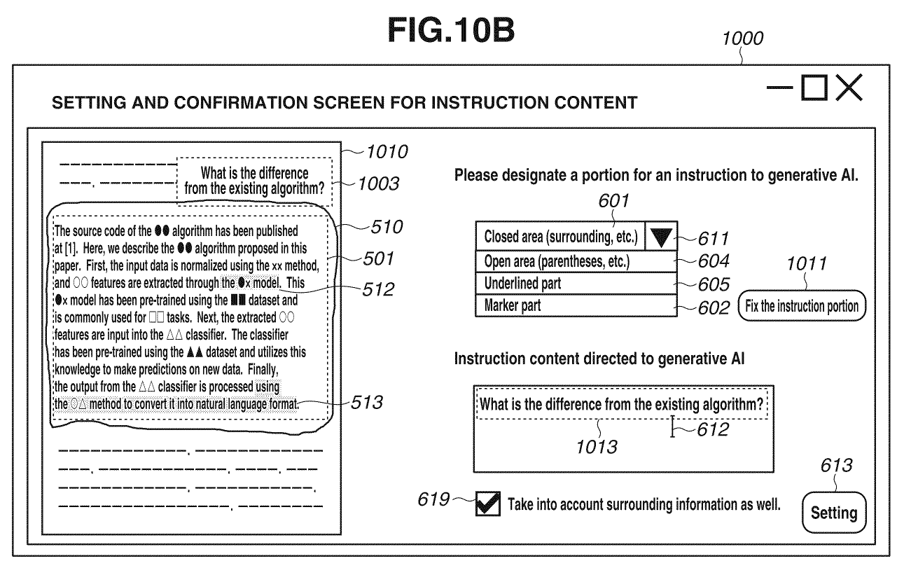

In the above-described first exemplary embodiment, the user who uses the information processing system 100 needs to input or designate an instruction sentence directed to generative AI in some way. On the other hand, in a fourth exemplary embodiment, in a case where there is a handwritten comment near an instruction portion directed to generative AI in a document image, the handwritten comment is reflected in an instruction sentence. The fourth exemplary embodiment is described with FIGS. 10A and 10B substituted for FIG. 6A used in the first exemplary embodiment and a document image 1010 illustrated in FIGS. 10A and 10B substituted for the document image 500 illustrated in FIG. 5A used in the first exemplary embodiment. In the fourth exemplary embodiment, points other than these are similar to those in the first exemplary embodiment and are, therefore, omitted from description here.

### Interface with User concerning Instruction to Generative AI

Each of FIGS. 10A and 10B is a diagram illustrating an example of a screen which is used for the user to perform setting and confirmation of an instruction content, on the display device 210 included in the information processing system 100 in the fourth exemplary embodiment. Among portions illustrated in each of FIGS. 10A and 10B, portions with the same reference numerals as those in FIG. 6A are similar to those in the first exemplary embodiment and are, therefore, omitted from description here.

The document image 1010 illustrated in FIG. 10A is an image obtained by adding a handwritten portion 1003 to the document image 500 illustrated in FIG. 5A. Moreover, a screen 1000 illustrated in FIG. 10B is a screen obtained by, in the screen 600 illustrated in FIG. 6A, substituting the document image 1010 for the document image 500 and substituting an instruction sentence 1013 for the instruction sentence 603.

When the user has pressed the list box 601 to select a notation indicating an instruction portion directed to generative AI and has then pressed an instruction portion confirmation button 1011, the information processing system 100 performs search processing for nearby handwritten characters with respect to the shape designated by the list box 601. The search processing is not illustrated, but can be performed as a processing operation in step S404 illustrated in FIG. 4.

As a specific example, the information processing system 100 searches for, among handwritten character strings located near the surrounding line 510 corresponding to “closed area” in the list box 601, a handwritten character string closest to the surrounding line 510. As the search method for nearby handwritten character strings, for example, the information processing system 100 calculates distances from a point on the surrounding line 510 to handwritten characters other than the “handwritten depiction portion representing an area”, and then selects a handwritten character string having the smallest distance. Thus, in the fourth exemplary embodiment, the information processing system 100 determines that a handwritten portion 1003 is an area applicable as a handwritten character string located near the surrounding line 510 and thus presents the handwritten portion 1003.

After that, the information processing system 100 performs OCR on the handwritten portion (character string) 1003 and thus acquires text 1013 as an OCR result. The information processing system 100 reflects the acquired text 1013 as an OCR result in an instruction sentence description field directed to generative AI illustrated in FIG. 10B. The reflected text 1013 can be modified by the user as with the first exemplary embodiment. Furthermore, in a case where no applicable handwritten portion is found near the surrounding line 510, the information processing system 100 operates in a manner similar to that in the first exemplary embodiment.

Moreover, the information processing system 100 can present, as nearby handwritten characters, all of the characters nearer than the distance from another “handwritten depiction portion representing an area” or all of the characters existing within a specific threshold value. For example, without depending on nearness or not, the information processing system 100 can present all of the handwritten characters other than the “handwritten depiction portion representing an area” in the order of closeness to the surrounding line 510.

Moreover, while, in the fourth exemplary embodiment, the information processing system 100 performs OCR after searching for the nearest handwritten characters, the timing for performing OCR is not limited to this. Moreover, when searching for the nearest handwritten characters, the information processing system 100 can preliminarily perform narrowing down into handwritten portions with handwritten characters other than marks depicted therein.

As described above, according to the fourth exemplary embodiment, the information processing system 100 is able to present, to the user, a handwritten comment existing near an instruction portion directed to generative AI as an instruction sentence. This enables reducing the user’s trouble of inputting or modifying an instruction sentence.

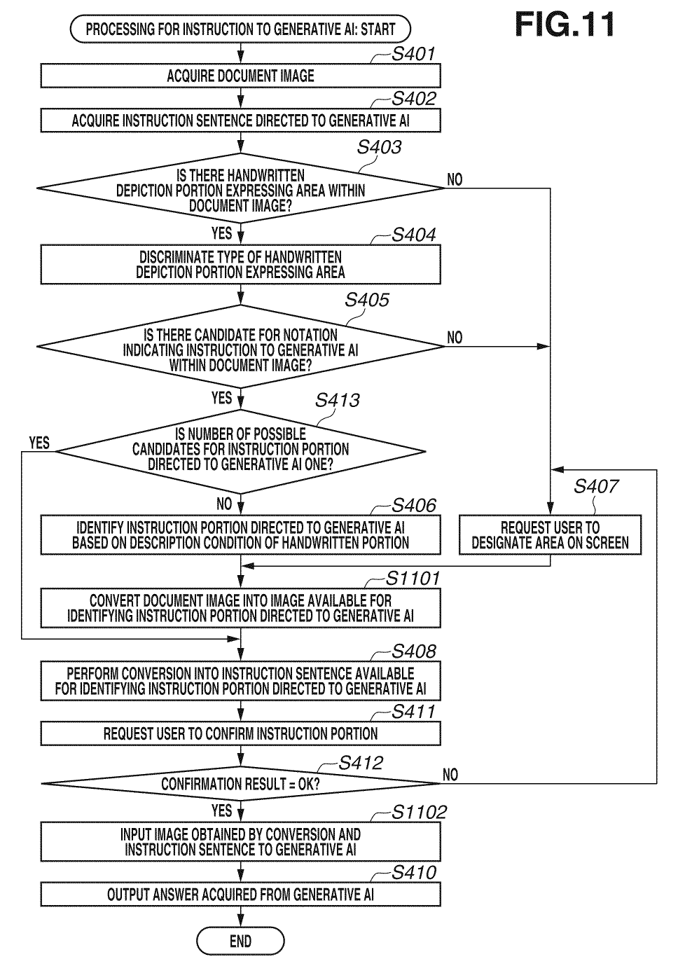

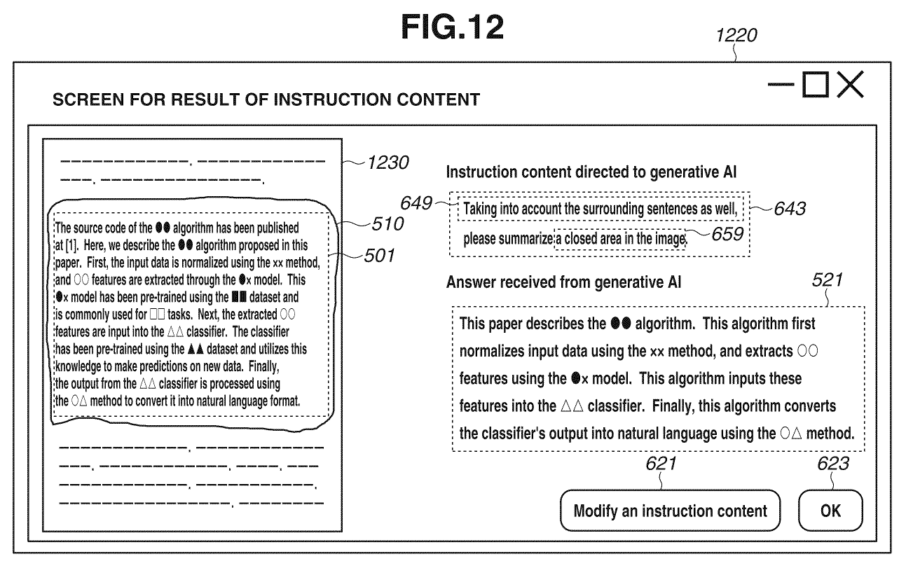

In the above-described first exemplary embodiment, to identify an instruction portion directed to generative AI, the information processing system 100 performs conversion of an instruction sentence. On the other hand, in a fifth exemplary embodiment, the information processing system 100 also performs conversion of, in addition to an instruction sentence, a document image which has been input. The fifth exemplary embodiment is described mainly with FIG. 11 substituted for FIG. 4 used in the first exemplary embodiment and FIG. 12 substituted for FIG. 6B used in the first exemplary embodiment. In the fifth exemplary embodiment, points other than these are similar to those in the first exemplary embodiment and are, therefore, omitted from description here.

### Information Processing System

FIG. 1 is, as explained above in the first exemplary embodiment, a block diagram illustrating a configuration example of the information processing system 100 in the fifth exemplary embodiment. In the fifth exemplary embodiment, with regard to elements having portions different from those in the first exemplary embodiment, only differences thereof are described.

The instruction content generation unit 155 receives an instruction sentence 114 from the information processing apparatus 101. Then, based on a handwritten portion in a document image 113 and the instruction sentence 114, the instruction content generation unit 155 generates an instruction image (not illustrated) available for identifying an instruction portion directed to generative AI and an instruction sentence (not illustrated) available for identifying an instruction portion directed to generative AI.

The instruction image available for identifying an instruction portion directed to generative AI is, for example, with respect to the document image 113, an image obtained by deleting handwriting other than the instruction portion, an image obtained by superimposing a translucent mask image on portions other than the instruction portion, or an image obtained according to a notation of, for example, “represent an instruction portion by red circular surrounding” which the engineer has preliminarily defined. Moreover, the instruction sentence available for identifying an instruction portion directed to generative AI is, for example, text obtained by substituting an instruction term in the instruction sentence 114 with a specific notation such as a “surrounding line” representing a handwritten portion on the document image.

The instruction content generation unit 155 fixes, as an instruction content, the instruction image and the instruction sentence available for identifying an instruction portion directed to generative AI. Furthermore, the instruction content generation unit 155 can generate an instruction sentence (not illustrated) obtained by additionally writing an OCR result acquired by the document image analysis unit 154 thereto and fix the generated instruction sentence and the document image 113 as an instruction content. Adding such an OCR result enables assisting in information acquisition from an image by generative AI.

### Use Sequence

FIG. 3 is, as also explained above in the first exemplary embodiment, a sequence diagram illustrating the flow of processing starting with inputting of an instruction to the generative AI server 102 and ending with outputting of an answer responsive to the instruction with use of a document image 113 and an instruction sentence 114 which have been acquired in the information processing apparatus 101. In the fifth exemplary embodiment, with regard to steps having portions different from those in the first exemplary embodiment, only differences thereof are described.

In step S317, the information processing server 103 converts the document image 113 received in step S312 into an image available for identifying a handwritten portion identified in step S316 as an instruction portion directed to generative AI. At this time, the information processing server 103 can then store the document image 113 in the storage 265 and perform conversion processing on a copy of the document image 113.

Moreover, the information processing server 103 converts the instruction sentence 114 received in step S314 into text available for identifying the handwritten portion identified in step S316 as an instruction portion directed to generative AI. After that, the information processing server 103 fixes the image obtained by conversion and the instruction sentence obtained by conversion as an instruction content directed to generative AI. Furthermore, the information processing server 103 can use, as an instruction content directed to generative AI, instead of the instruction sentence obtained by conversion, an instruction sentence in which both text obtained by performing OCR on the document image 113 and the instruction sentence obtained by conversion have been reflected.

### Processing for Instruction to Generative AI

FIG. 11 is a flowchart illustrating the flow of processing starting with issuing an instruction to the generative AI server 102 and ending with outputting an answer acquired from the generative AI server 102, in the fifth exemplary embodiment. Among processing operations illustrated in the flowchart of FIG. 11, processing operations with the same step numbers as those in the flowchart of FIG. 4 are basically similar to those in the first exemplary embodiment and are, therefore, omitted from description here. However, among the processing operations with the same step numbers as those in in the flowchart of FIG. 4, with regard to processing operations having different portions from those in the first exemplary embodiment, only such differences are described.

In step S1101, the CPU 261 converts the document image acquired in step S401 into an image enabling clearly knowing the instruction portion identified in step S406 or step S407. The conversion of the image is described with reference to FIG. 6A. As also explained above in step S405, in the document image 500, the candidate for a notation indicating an instruction portion includes two candidates, i.e., the surrounding line (510) and the marker areas (512 and 513). Here, suppose that the user has selected “closed area” in the list box 601. Thus, suppose that the user has selected the surrounding line (510) as a notation indicating an instruction portion.

At this time, the CPU 261 generates an image obtained by targeting, for processing, the surrounding line (510) from the handwritten portions (510, 512, and 513) of the document image 500. Thus, the image enabling clearly knowing an instruction portion is an image obtained by superimposing a layer of only the surrounding line 510 being a notation indicating an instruction portion on the layer of the printed portions 501 to 503. The image obtained by this superimposition is an image 1230 illustrated in FIG. 12.

Furthermore, the image enabling clearly knowing an instruction portion can be generated in the form of overwriting the document image 500 or can be generated separately from the document image 500. Moreover, although not described in the fifth exemplary embodiment, the CPU 261, without using the surrounding line 510 itself, can change a notational method for the surrounding line 510 with respect to an instruction portion directed to generative AI. For example, with respect to an instruction portion indicated by the surrounding line 510, the CPU 261 depicts, instead of the surrounding line 510, for example, a red surrounding line, which is preliminarily defined as a notation for an instruction portion directed to generative AI.

In this case, in step S408, the CPU 261 substitutes text 609 included in the instruction sentence 603 with not information in the list box but preliminarily defined text such as “red encircled portion”. This enables performing conversion into an instruction sentence enabling clearly knowing an instruction portion directed to generative AI. Furthermore, the preliminarily defined text can be set by the user or administrator. Moreover, while, in the fifth exemplary embodiment, conversion is performed in such a way as to delete a handwritten portion other than a notation indicating an instruction portion from an image to be input to generative AI, instead of deletion, a translucent mask can be drawn.

In step S1102, the CPU 261 fixes the image obtained by conversion in step S1101 and the instruction sentence obtained by conversion in step S408 as an instruction content directed to generative AI. After that, the CPU 261 transmits the fixed instruction content to the generative AI server 102. Furthermore, the CPU 261 can use, as an instruction content directed to generative AI, instead of the instruction sentence acquired in step S408, an instruction sentence obtained by modifying the instruction sentence acquired in step S408.

### Interface with User concerning Instruction to Generative AI

FIG. 12 is a diagram illustrating an example of a screen used for the user to confirm a result of issuing an instruction to generative AI in the fifth exemplary embodiment. Among portions illustrated in FIG. 12, portions with the same reference numerals as those in FIG. 6B are similar to those in the first exemplary embodiment and are, therefore, omitted from description here.

The screen 1220 is a screen obtained by substituting the document image 500 in the screen 620 illustrated in FIG. 6B with an image 1230. Thus, the image which has been input to generative AI is changed from the document image 500 to the image 1230.

As described above, according to the fifth exemplary embodiment, generative AI is able to identify an instruction portion directed to generative AI from both an input image and an instruction sentence. This enables reducing the probability of generative AI falsely recognizing an instruction portion which the user has designated, and enables the user to issue an instruction which is in accord with the user’s intention.

In the above-described first exemplary embodiment, an example in which the information processing system 100 converts an instruction sentence directed to generative AI into an instruction sentence available for identifying an instruction portion has been described. In a sixth exemplary embodiment, an example in which the information processing system 100 clarifies an instruction portion by performing conversion of an image to be input to generative AI is described.

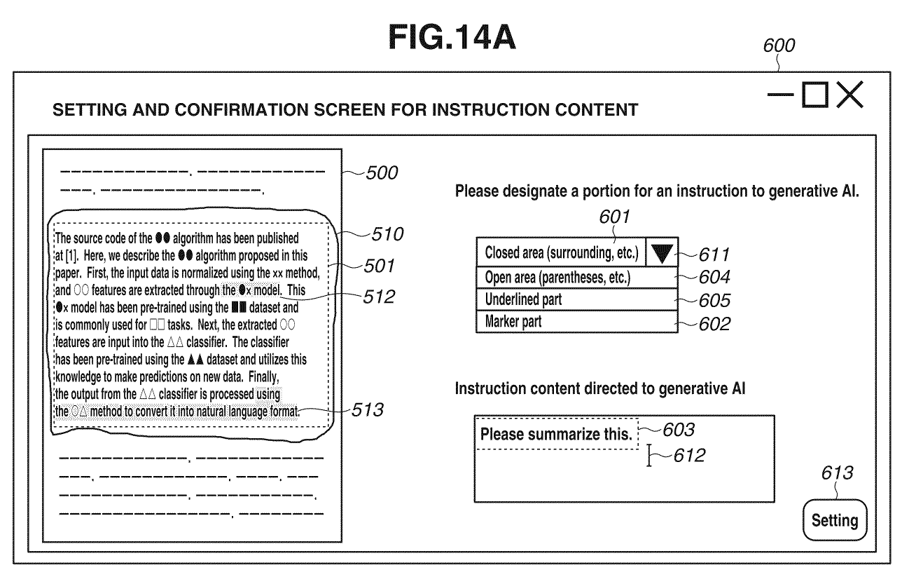

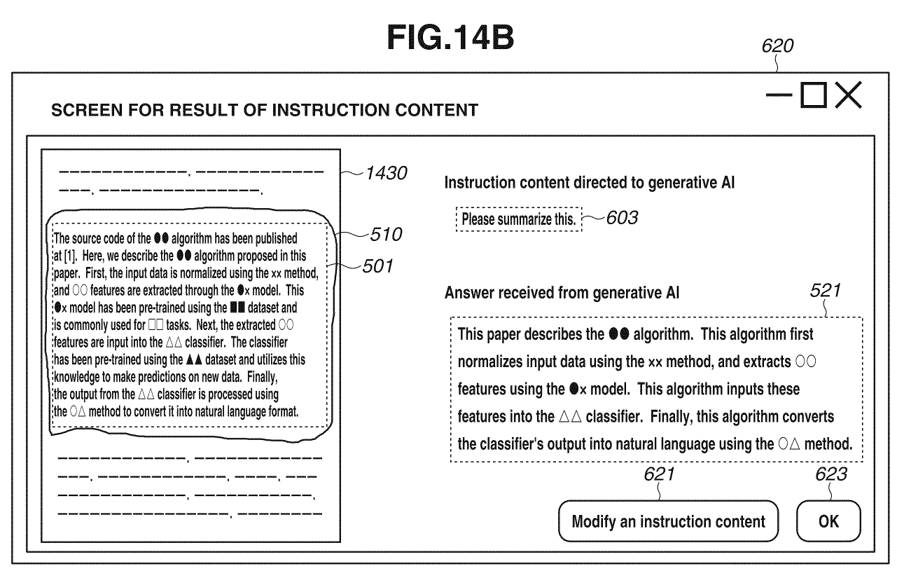

Portions similar to those in the first exemplary embodiment are omitted from description here. However, even in portions which are omitted from description, portions which are described with reference to FIGS. 6A and 6B are assumed to be substituted with portions which are described with reference to FIGS. 14A and 14B.

### Information Processing System

The configuration of the information processing system 100 is similar to that described in the first exemplary embodiment with reference to FIG. 1. However, in the sixth exemplary embodiment, a configuration in which the information processing server 103 is not provided with the instruction sentence analysis unit 159 can be employed. In this case, an instruction sentence 114 which the instruction sentence acquisition unit 152 has acquired is output directly (without passing through the instruction sentence analysis unit 159) to the instruction content generation unit 155.

In the sixth exemplary embodiment, the instruction content generation unit 155 receives the instruction sentence 114 from the information processing apparatus 101. Then, based on a handwritten portion in the document image 113 and the instruction sentence 114, the instruction content generation unit 155 generates an instruction image (not illustrated) available for identifying an instruction portion in the instruction sentence 114. The instruction image is, for example, an image obtained by deleting handwriting other than the instruction portion from the document image 113. The instruction content generation unit 155 fixes the instruction sentence 114 and the instruction image as an instruction content.

Furthermore, the instruction content generation unit 155 can generate an instruction sentence (not illustrated) in which an OCR result acquired by the document image analysis unit 154 and the instruction sentence 114 have been described and then fix the generated instruction sentence and the instruction image as an instruction content.

The sixth to ninth exemplary embodiments are described with use of a configuration in which the information processing server 103 is not provided with the instruction sentence analysis unit 159.

### Apparatus Configuration

Configuration examples of the information processing apparatus 101, the generative AI server 102, and the information processing server 103 included in the information processing system 100 are similar to those described above in the first exemplary embodiment with reference to FIGS. 2A to 2C.

### Use Sequence

The flow of processing starting with inputting of an instruction to the generative AI server 102 and ending with outputting of an answer responsive to the instruction with use of a document image 113 and an instruction sentence 114 which have been acquired in the information processing apparatus 101 is described with reference to FIG. 3.

Here, since processing operations other than a processing operation in step S317 are similar to those described above in the first exemplary embodiment, here, only the processing operation in step S317 is described.

In step S317, the information processing server 103 converts the document image 113 received in step S312 into an image available for identifying a handwritten portion identified in step S316 as an instruction portion directed to generative AI. At this time, the information processing server 103 can then store the document image 113 in the storage 265 and perform conversion processing on a copy of the document image 113.

The information processing server 103 fixes the image obtained by conversion and the instruction sentence 114 received in step S314 as an instruction content directed to generative AI. Furthermore, the information processing server 103 can use, as an instruction content directed to generative AI, instead of the instruction sentence 114, an instruction sentence in which both text obtained by performing OCR on the document image 113 and the instruction sentence 114 have been reflected.

### Processing for Instruction to Generative AI

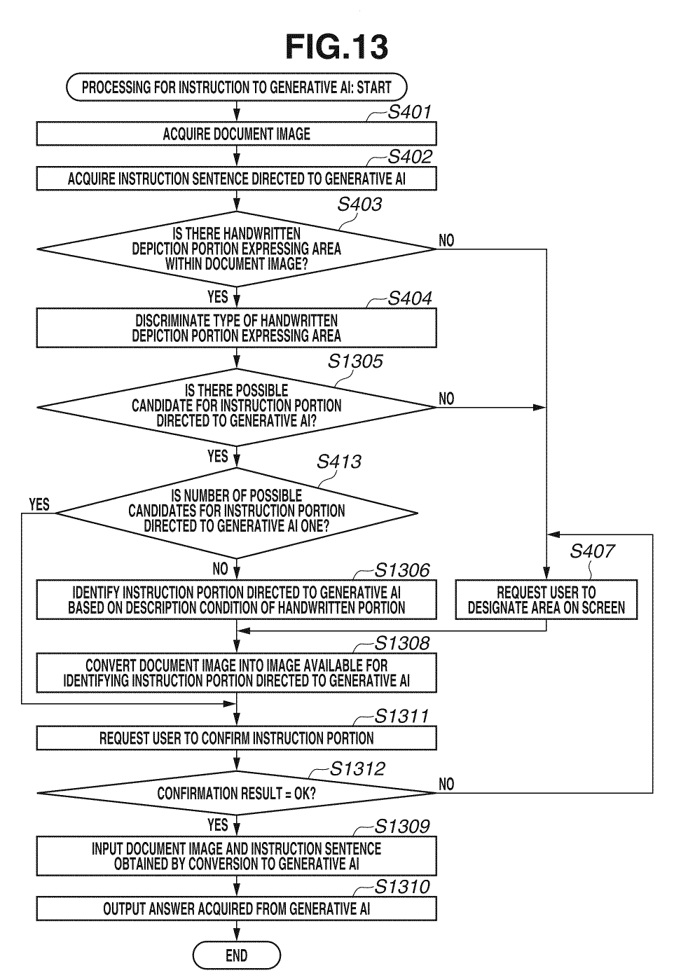

FIG. 13 is a flowchart illustrating the flow of processing starting with issuing an instruction to the generative AI server 102 and ending with outputting an answer acquired from the generative AI server 102, which has been described with reference to FIG. 3. A series of processing operations illustrated in the flowchart of FIG. 13 is assumed to be performed by the CPU 261 of the information processing server 103 loading program code stored in the ROM 262 or the storage 265 onto the RAM 264 and executing the program code.

Furthermore, processing operations similar to those described above in the first exemplary embodiment with reference to FIG. 4 are assigned the respective same step numbers as those in the first exemplary embodiment even in FIG. 13 and are omitted from description here. However, even in processing operations omitted from description, processing operations which are described with reference to FIGS. 6A and 6B are assumed to be substituted with processing operations which are described with reference to FIGS. 14A and 14B.

In step S1305, the CPU 261 determines whether there is a candidate for a notation indicating “a portion which the instruction sentence acquired in step S402 designates” from among the types of shapes serving as the result of discrimination performed in step S404. If it is determined that there is a candidate for a notation indicating “a portion which the instruction sentence designates” from among the types of shapes serving as the result of discrimination performed in step S404 (YES in step S1305), the CPU 261 advances the processing to step S413. If it is determined that there is no candidate for a notation indicating “a portion which the instruction sentence designates” from among the types of shapes serving as the result of discrimination performed in step S404 (NO in step S1305), the CPU 261 advances the processing to step S407.

Furthermore, the portion which the instruction sentence designates indicates which area in the document image acquired in step S401 the instruction sentence designates. Moreover, for example, in a case where the “portion which the instruction sentence designates” is not confined in the instruction sentence, such as “Please perform summarization” instead of “Please summarize this”, the CPU 261 advances the processing to step S407. Moreover, for example, in a case where the “portion which the instruction sentence designates” is actually present in the instruction sentence but is not able to be detected, such as the case where, with regard to an instruction sentence “Please summarize a surrounded portion”, the surrounded portion has not been able to be detected from within the image, the CPU 261 advances the processing to step S407.

Here, determination as to whether there is a candidate for a notation indicating “a portion which the instruction sentence designates” is specifically described with reference to FIG. 14A. FIG. 14A illustrates an example of a screen which is used for the user to perform setting and confirmation of an instruction content.

Text 603 is an instruction sentence directed to generative AI for the document image 500, which the user has input with use of a cursor 612. The term “here” in the text 603 is an instruction term indicating a specific portion in the document image, and is assumed to, as the user’s intention, point to text in a closed area defined by the surrounding line 510 written on the document image. Thus, the instruction portion directed to generative AI is assumed to be the whole of a text area surrounded by a surrounding line such as the surrounding line 510 in the document image.

The candidate for a notation indicating “a portion which the instruction sentence designates” is a handwritten depiction portion representing an area, to which the term “here” is likely to point in the text 603. Furthermore, in a case where there is a plurality of handwritten depiction portions each representing an area having the same shape, the CPU 261 collectively handles the plurality of handwritten depiction portions as a single candidate.

As explained above in step S404, the handwritten depiction portion representing an area includes two types of shapes such as the closed area (surrounding line 510) and the marker parts (marker areas 512 and 513).

Thus, the specific candidate for a notation indicating “a portion which the instruction sentence designates” includes two candidates, i.e., the surrounding line (510) and the marker areas (512 and 513). Therefore, the CPU 261 determines that there is a candidate for a notation indicating “a portion which the instruction sentence designates”.

Furthermore, although not been described in the sixth exemplary embodiment, for example, in a case where, in step S404, the handwritten depiction portion representing an area has been discriminated into a cluster which is unclear about from where to where the handwritten depiction portion points to, such as writing of an asterisk or arrow, the term “here” in the text 603 is not clearly known. Therefore, in this case, the CPU 261 determines that there is no candidate for a notation indicating “a portion which the instruction sentence designates”.

In step S413, the CPU 261 determines whether the number of candidates for a notation indicating “a portion which the instruction sentence designates” determined in step S1305 is one. If it is determined that the number of candidates for a notation indicating “a portion which the instruction sentence designates” is one (YES in step S413), the CPU 261 advances the processing to step S1311. If it is determined that the number of candidates for a notation indicating “a portion which the instruction sentence designates” is plural (NO in step S413), the CPU 261 advances the processing to step S1306.

Here, determination as to whether the number of candidates for a notation indicating “a portion which the instruction sentence designates” is one is described with reference to FIG. 14A. As explained above in step S405, the candidate for a notation indicating “a portion which the instruction sentence 603 designates” includes two candidates, i.e., the surrounding line (510) and the marker areas (512 and 513). Therefore, the CPU 261 determines that there is a plurality of candidates for a notation indicating “a portion which the instruction sentence designates”.

Furthermore, for example, in a case where the candidate for a notation indicating “a portion which the instruction sentence designates” includes only the marker areas (512 and 513), which have the same marker shape, the CPU 261, therefore, deems the marker areas (512 and 513) as one type of marker area and thus determines that the number of candidates for a notation indicating “a portion which the instruction sentence designates” is one. Moreover, the CPU 261 can integrate step S1305 and step S413 into one determination.

In step S1306, the CPU 261 presents, to the user, the candidate for a notation indicating the instruction portion directed to generative AI detected at the time of determination in step S1305, and accepts selection from the candidate by the user. The CPU 261 identifies an instruction portion based on the notation indicating the instruction portion directed to generative AI selected by the user. After that, the CPU 261 advances the processing to step S1308.

In step S1308, the CPU 261 converts the document image acquired in step S401 into an image enabling clearly knowing the instruction portion identified in step S1306 or step S407. Conversion of the image is described with reference to FIG. 14A.

As also explained above in step S1305, the candidate for a notation indicating an instruction portion in the document image 500 includes two candidates, i.e., the surrounding line (510) and the marker areas (512 and 513). Here, suppose that the user has selected “closed area” in the list box 601. Thus, suppose that the user has selected the surrounding line (510) as a notation indicating an instruction portion. At this time, the CPU 261 generates an image obtained by targeting, for processing, the surrounding line (510) from the handwritten portions (510, 512, and 513) in the document image 500.

Thus, the image enabling clearly knowing an instruction portion is an image obtained by superimposing a layer of only the surrounding line 510 being a notation indicating an instruction portion on the layer of printed portions 501 to 503.

The image obtained by this superimposition is an image 1430 illustrated in FIG. 14B. Furthermore, the image enabling clearly knowing an instruction portion can be generated in the form of overwriting the document image 500 or can be generated separately from the document image 500.

In step S1311, the CPU 261 presents the instruction sentence acquired in step S402 and the image obtained by conversion in step S1308 to the user who uses the information processing system 100, and prompts the user to confirm whether those are in accord with the user’s intention. Examples of the method for prompting the user for confirmation include a method of presenting the instruction sentence and the image on a confirmation screen to the user who uses the information processing system 100 and causing the user to, if everything is in order, press an “OK” button and, if correction is needed, press a “correction” button.

In step S1312, the CPU 261 determines, with use of the confirmation result acquired in step S1311, whether the instruction sentence acquired in step S402 and the image obtained by conversion in step S1308 are in accord with the intention of the user who uses the information processing system 100. If it is determined that those are in accord with the intention of the user who uses the information processing system 100 (YES in step S1312), the CPU 261 advances the processing to step S1309. If it is determined that those are not in accord with the intention of the user who uses the information processing system 100 (NO in step S1312), the CPU 261 advances the processing to step S407.

For example, when having detected pressing of the “OK” button in step S1311, the CPU 261 determines that those are in accord with the intention of the user who uses the information processing system 100. Moreover, when having detected pressing of the “correction” button in step S1311, the CPU 261 determines that those are not in accord with the intention of the user who uses the information processing system 100.

In step S1309, the CPU 261 fixes the instruction sentence acquired in step S402 and the image obtained by conversion in step S1308 as an instruction content directed to generative AI. After that, the CPU 261 transmits the fixed instruction content to the generative AI server 102. Furthermore, the CPU 261 can use, as an instruction content directed to generative AI, instead of the instruction sentence acquired in step S402, an instruction sentence obtained by adding modification to the instruction sentence acquired in step S402.

Here, the instruction sentence obtained by adding modification is described with reference to FIG. 5D. FIG. 5D is a diagram illustrating an OCR result 530 obtained from the document image 500 illustrated in FIG. 5A. The user is assumed to have input text 603 illustrated in FIG. 14A as an instruction sentence directed to generative AI. At this time, the instruction sentence obtained by adding modification is text configured as, for example, a two-chapter structure including chapters indicating “instruction” and “OCR result”. Then, the instruction sentence obtained by adding modification refers text in which text 603 accompanied by a preface “Taking into account the OCR result, in the image” is inserted into the chapter indicating “instruction” and the OCR result 530 is inserted into the chapter indicating “OCR result”.

Furthermore, as another example, the instruction sentence obtained by adding modification includes, for example, text in which a preface sentence for clarifying an instruction to generative AI such as “Please execute the following instruction with respect to the image shown below.” has been inserted in front of text 603. This may cause the appearance of an advantageous effect in which the processing performance in generative AI is made better by adding a result obtained by performing OCR than the case of inputting a document image to generative AI and causing the generative AI to process the document image.

In step S1310, the CPU 261 acquires an answer received from the generative AI server 102 responsive to the instruction content input in step S1309. After that, the CPU 261 presents the acquired answer to the user. An example of the presentation to the user is described with reference to FIG. 5C and FIG. 14B. FIG. 5C is a diagram illustrating a result obtained by summarizing the text 501. FIG. 14B illustrates an example of a screen which is used for the user to confirm a result obtained by issuing an instruction to generative AI.

The CPU 261 displays, on a screen 620, a summarization result 521 as well as the instruction sentence 603 input by the user and the image 1430 which has been input to generative AI. At this time, the CPU 261 can add modification to the text (summarization result) 521 to change that into an easily comprehensible form for the user. Moreover, the CPU 261 can display, instead of the instruction sentence 603, an instruction sentence obtained by modifying the instruction sentence 603 and inputting the modified instruction sentence 603 to generative AI, or can display only the summarization result 521. While, in the sixth exemplary embodiment, the CPU 261 performs displaying on a summarization result screen, the CPU 261 can be configured to be able to perform outputting in the form of, for example, metadata or comment regarding a document image.

### Interface with User concerning Instruction to Generative AI

An interface with the user concerning an instruction to generative AI is described with reference to FIGS. 14A and 14B. FIG. 14A is a diagram illustrating an example of a screen which is used for the user to perform manipulation and confirmation, on the display device 210 included in the information processing system 100.

FIG. 14A differs from FIG. 6A in that the screen 600 illustrated in FIG. 14A does not include the check box 619.

Upon detecting pressing of the setting button 613 by the user, the information processing system 100 fixes an instruction portion directed to generative AI and an instruction sentence. In the sixth exemplary embodiment, the information processing system 100 fixes the instruction portion directed to generative AI as a list box 601 and the instruction sentence as text 603. After that, as explained above in step S1308, based on the fixed instruction portion and instruction sentence, the information processing system 100 performs conversion into an image enabling clearly knowing an instruction portion directed to generative AI.

Next, the case of confirming an answer received from generative AI responsive to the instruction content is described. FIG. 14B illustrates an example of a screen which is used for the user to confirm a result obtained by issuing an instruction to generative AI. The screen 620 is configured with an image 1430 which has been used for an instruction to generative AI, an instruction sentence 603 directed to generative AI, an answer result 521 received from generative AI, a “modify an instruction content” button 621, and an “OK” button 623.

As explained above in step S1310, the information processing system 100 presents an answer received from generative AI to the user. Upon detecting pressing of the “modify an instruction content” button 621 by the user, the information processing system 100 causes the screen 620 to transition to the screen 600. Moreover, upon detecting pressing of the “OK” button 623 by the user, the information processing system 100 deems that the answer received from generative AI has been completed, closes the screen 620, and thus ends the system.

As described above, according to the sixth exemplary embodiment, the information processing system 100 converts a document image into an image available for identifying an instruction portion directed to generative AI, so that it is possible to, while reducing the user’s effort of thinking of an instruction sentence, issue an instruction which is in accord with the user’s intention.

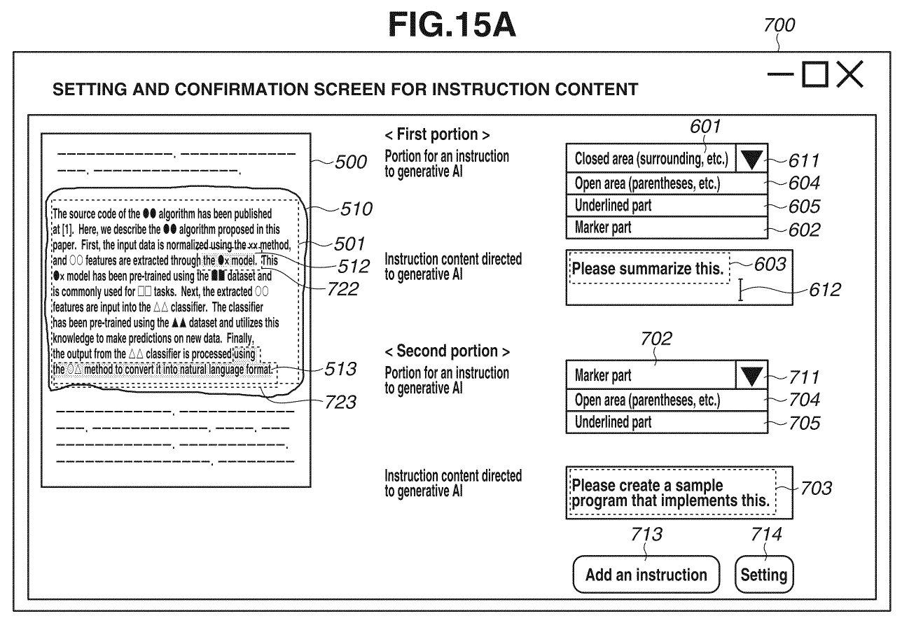

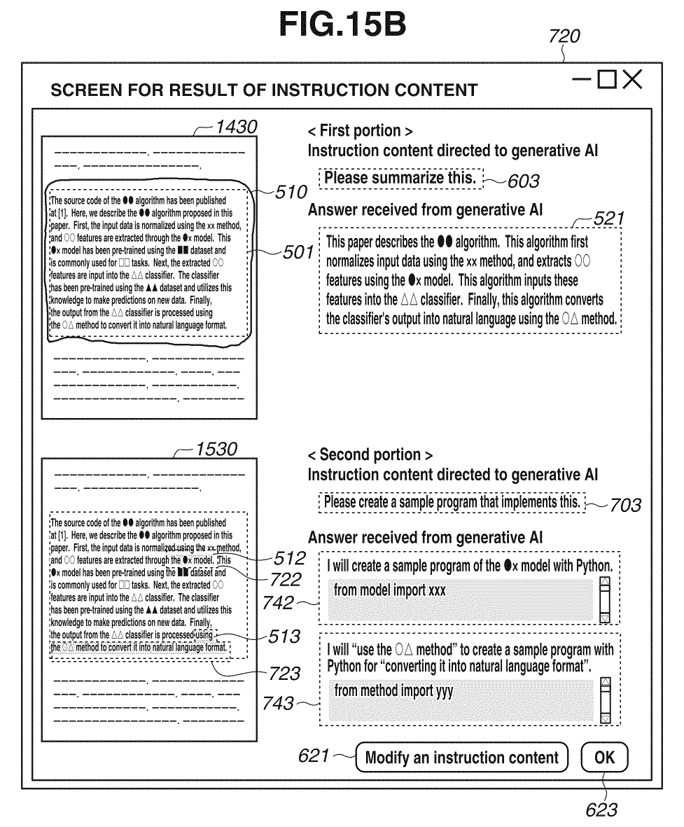

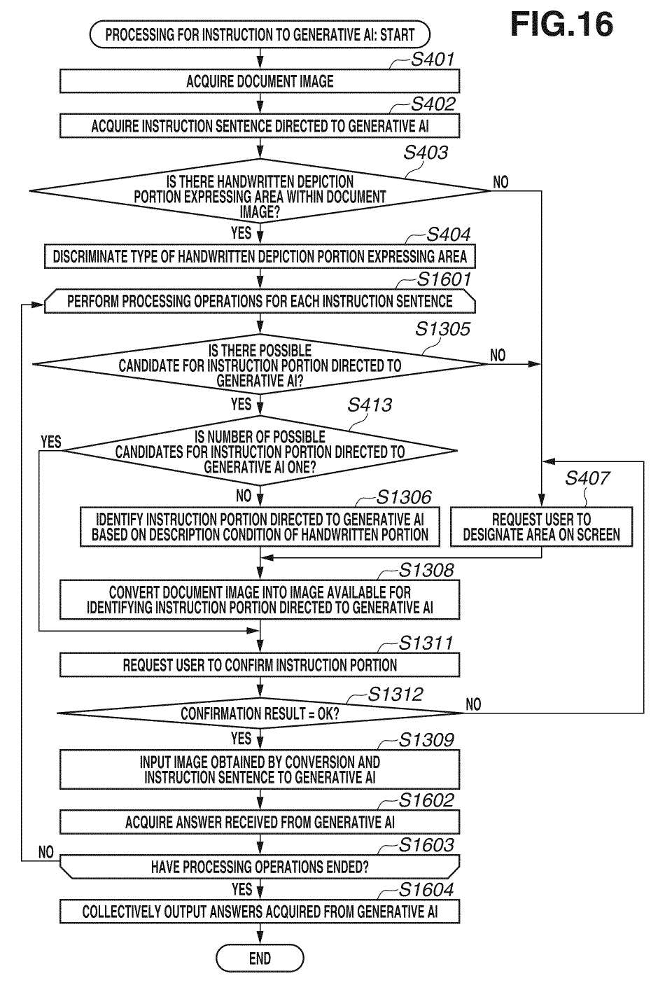

In the sixth exemplary embodiment, in a case where there is only one type of notation indicating an instruction to generative AI, the information processing system 100 issues an instruction to generative AI. On the other hand, in a seventh exemplary embodiment, in a case where there is a plurality of types of notation indicating an instruction to generative AI, the information processing system 100 switches between instructions to generative AI with respect to the respective types of notation. The seventh exemplary embodiment is described mainly with FIGS. 15A and 15B substituted for FIGS. 14A and 14B used in the sixth exemplary embodiment and FIG. 16 substituted for FIG. 13 used in the sixth exemplary embodiment. In the seventh exemplary embodiment, points other than these are similar to those in the sixth exemplary embodiment and are, therefore, omitted from description here.

### Processing for Instruction to Generative AI

FIG. 16 is a flowchart illustrating the flow of processing starting with issuing an instruction to the generative AI server 102 and ending with outputting an answer acquired from the generative AI server 102 in the seventh exemplary embodiment. Among processing operations illustrated in the flowchart of FIG. 16, processing operations with the same step numbers as those in the flowchart of FIG. 13 are basically similar to those in the sixth exemplary embodiment and are, therefore, omitted from description here. However, among the processing operations with the same step numbers as those in in the flowchart of FIG. 13, with regard to processing operations having different portions from those in the sixth exemplary embodiment, only such differences are described.

In step S402, the CPU 261 acquires an instruction sentence directed to generative AI obtained by the information processing apparatus 101 accepting an input from the user. At this time, the CPU 261 acquires one instruction sentence per one type of notation indicating an instruction to generative AI. This is described with reference to FIG. 15A. FIG. 15A illustrates an example of a screen which is used for the user to perform setting and confirmation of an instruction content.

In the seventh exemplary embodiment, there exist two instruction sentences (text 603 and text 703). The text 603 is an instruction sentence directed to generative AI which the user has input via the cursor 612 with respect to the text 501 (text in “closed area” in the list box 601) included in the document image 500. The text 703 is an instruction sentence directed to generative AI which the user has input via the cursor 612 with respect to texts 722 and 723 (texts in “marker part” in the list box 602) included in the document image 500. FIGS. 15A and 15B are described below in detail in chapter “Interface with User concerning Instruction to Generative AI”.

In step S1601, the CPU 261 performs processing operations in step S1305 to step S1602 for each instruction sentence acquired in step S402. For example, in the example illustrated in FIG. 15A, since, as explained above in step S402, there exist two instruction sentences (text 603 and text 703), the CPU 261 performs processing operations in step S1305 to step S1602 for each of the text 603 and the text 703. Thus, the CPU 261 performs processing operations in step S1305 to step S1602 two times.

In step S1602, the CPU 261 acquires an answer received from the generative AI server 102 responsive to the instruction content input in step S1309.

In step S1603, the CPU 261 determines whether the processing operations have ended with respect to all of the instruction sentences acquired in step S402, and then repeats the processing operations in step S1305 to step S1602 until it is determined that the processing operations have ended with respect to all of the instruction sentences.

In step S1604, the CPU 261 collects the answers acquired in step S1602 for the respective instruction sentences and presents the collected answers to the user. An example of the presentation to the user is described with reference to FIG. 15B. FIG. 15B illustrates an example of a screen which is used for the user to confirm a result obtained by issuing an instruction to generative AI. The CPU 261 displays, as the first answer, an answer result 521 as well as the instruction sentence 603 input by the user and the image 1430 which has been input to generative AI, on the screen 720.

Moreover, the CPU 261 displays, as the second answer, answer results 742 and 743 as well as the instruction sentence 703 input by the user and the image 1530 which has been input to generative AI, on the screen 720. At this time, the CPU 261 can add modification to the answer result 521 and the answer results 742 and 743 to change those into an easily comprehensible form for the user.

Moreover, the CPU 261 can display, instead of the instruction sentence 603 and the instruction sentence 703, instruction sentences obtained by modifying the instruction sentence 603 and the instruction sentence 703 and inputting the modified instruction sentences 603 and 703 to generative AI, or can display only the answer result 521 and the answer results 742 and 743. While, in the seventh exemplary embodiment, the CPU 261 performs displaying on an answer result screen, the CPU 261 can be configured to be able to perform outputting in the form of, for example, metadata or comment regarding a document image, or can be configured to be able to perform outputting in the form of, for example, paper from the information processing apparatus 101.

Furthermore, while, in the seventh exemplary embodiment, the CPU 261 performs processing operations in step S1305 to step S1602 for each instruction sentence, the CPU 261 can collectively perform such processing operations at one time. Conversely, the CPU 261 can perform a processing operation in step S1604 for each instruction sentence or each instruction portion.

### Interface with User concerning Instruction to Generative AI

FIGS. 15A is a diagram illustrating an example of a screen which is used for the user to perform manipulation and confirmation, on the display device 210 included in the information processing system 100 in the seventh exemplary embodiment. Among portions illustrated in FIG. 15A, portions with the same reference numerals as those in FIG. 14A are similar to those in the sixth exemplary embodiment and are, therefore, omitted from description here.

First, the case of fixing an instruction portion directed to generative AI is described. FIG. 15A illustrates an example of a screen which is used for the user to set and confirm an instruction content in the seventh exemplary embodiment. The screen 700 includes, with respect to each of two types of notation indicating an instruction to generative AI within the document image 500, list boxes and a pull-down button for selecting the type of notation indicating an instruction to generative AI and an input field for an instruction sentence.

The first portion is similar to that in the sixth exemplary embodiment and is, therefore, omitted from description, and, in the following description, only the second portion is described. All of the types of shape to be discriminated in step S404 are displayed in the list boxes 601, 602, 604, and 605 as options for notations each indicating an instruction to generative AI.

In the first portion, “closed area” in the list box 601 is selected by the user as a notation indicating an instruction to generative AI. Therefore, in options for notations each indicating an instruction to generative AI in the second portion, the information processing system 100 presents, to the user, list boxes 702, 704, and 705 with “closed area” removed. Upon detecting pressing of the pull-down button 711 by the user, the information processing system 100 displays the list boxes 704 and 705, which are options not yet selected. Furthermore, as also explained above in the sixth exemplary embodiment, the options can be not list boxes but other form options such as radio buttons as long as they are able to fulfill the function of selection.

Moreover, as explained above in step S402, the information processing system 100 accepts inputting of an instruction sentence 703 directed to generative AI from the user. The method of inputting an instruction sentence is similar to that in the sixth exemplary embodiment and is, therefore, omitted from description.

Moreover, upon detecting pressing of a button 713 by the user, the information processing system 100 adds new notations each indicating an instruction to generative AI and a new input field for an instruction sentence. Furthermore, the upper limit of the number of sets of notations and an input field able to be added is the number of types of shape to be discriminated in step S404.

Finally, upon detecting pressing of the button 714 by the user, the information processing system 100 fixes instruction portions and instruction sentences with respect to all of the notations each indicating an instruction to generative AI.

In the seventh exemplary embodiment, since the notation indicating an instruction to generative AI in the first portion is “closed area” in the list box 601, the information processing system 100 fixes an instruction portion in the first portion as text area 501 surrounded by the surrounding line 510 and fixes an instruction sentence in the first portion as text 603.

Moreover, since the notation indicating an instruction to generative AI in the second portion is the list box 702, the information processing system 100 fixes instruction portions in the second portion as text areas 722 and 723 of the marker areas 512 and 513 and fixes an instruction sentence in the second portion as text 703. After that, as explained above in step S1308, based on the fixed instruction portions and instruction sentences, the information processing system 100 converts each of the instruction sentences into an image enabling clearly knowing an instruction portion directed to generative AI.

Next, the case of confirming an answer received from generative AI responsive to the instruction content is described. FIG. 15B illustrates an example of a screen which is used for the user to confirm a result obtained by issuing an instruction to generative AI in the seventh exemplary embodiment. The screen 720 includes, in addition to elements included in the screen 620 illustrated in FIG. 14B, an image 1530 which has been used for an instruction in the second portion directed to generative AI, an instruction sentence 703 in the second portion directed to generative AI, and answer results 742 and 743 received from generative AI regarding the second portion.

As explained above in step S1604, the information processing system 100 presents, to the user, an answer received from generative AI for each of notations indicating the respective instructions to generative AI. At this time, the information processing system 100 lumps together images (1430 and 1530) which has been used for an instruction to generative AI, instruction sentences (603 and 703), and answers received from generative AI (521, 742, and 743) and presents those for each of notations indicating the respective instructions to generative AI.

Furthermore, for each of notations indicating the respective instructions to generative AI, instead of presenting an answer received from generative AI to the user, the information processing system 100 can take the form of interactively switching displaying. For example, after detecting selection of the surrounding line 510 or the marker areas 512 and 513 by the user with use of the document image 500, the information processing system 100 can display an instruction sentence directed to generative AI and an answer corresponding to the detected handwritten depiction portion representing an area.

At this time, the information processing system 100 can alter the notation indicating an instruction to generative AI and thus clearly identify such notation by text.

As described above, according to the seventh exemplary embodiment, even in a case where there is a plurality of types of notation indicating an instruction to generative AI, it is possible to issue an instruction which is in accord with the user’s intention, by switching between instruction contents directed to generative AI for the respective types of notation.

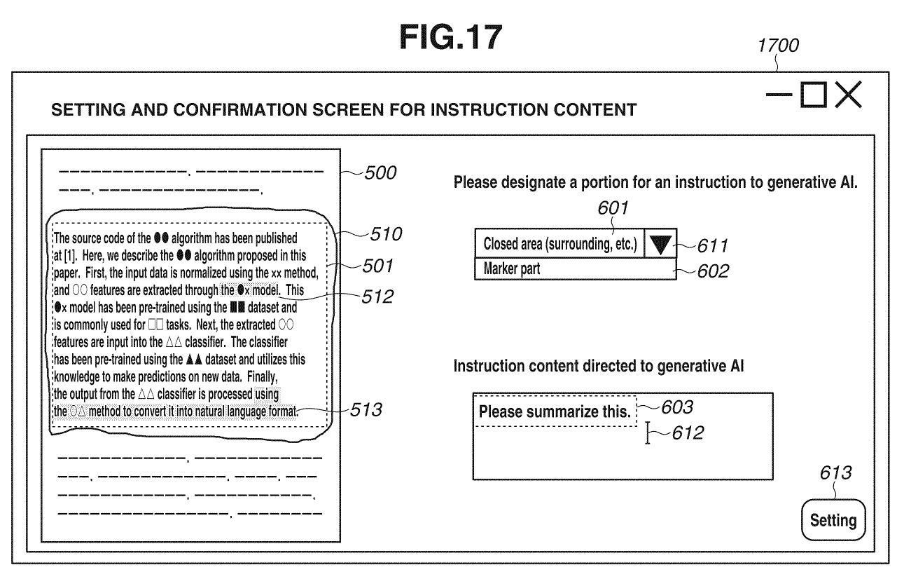

In the above-described sixth exemplary embodiment, in a case where the user who uses the information processing system 100 performs setting of an instruction content, the information processing system 100 presents, as options of candidates for an instruction portion directed to generative AI, all of the types of shape to be discriminated in step S404 illustrated in FIG. 13. On the other hand, in an eighth exemplary embodiment, the information processing system 100 presents, as the options, only types of shape included in a document image acquired in step S401 illustrated in FIG. 13. The eighth exemplary embodiment is described with FIG. 17 substituted for FIG. 14A used in the sixth exemplary embodiment. In the eighth exemplary embodiment, points other than these are similar to those in the sixth exemplary embodiment and are, therefore, omitted from description here.

### Interface with User concerning Instruction to Generative AI

FIG. 17 is a diagram illustrating an example of a screen which is used for the user to perform setting and confirmation of an instruction content, on the display device 210 included in the information processing system 100 in the eighth exemplary embodiment. Among portions illustrated in FIG. 17, portions with the same reference numerals as those in FIG. 14A are similar to those in the sixth exemplary embodiment and are, therefore, omitted from description here.

The screen 1700 is configured with a document image 500 which the user has input, list boxes 601 and 602 for selecting an instruction portion, a pull-down button 611, an instruction sentence 603, a cursor 612 for inputting an instruction sentence, and a “setting” button 613 for fixing the instruction content.

As explained above in step S404 illustrated in FIG. 13, with regard to the document image 500, the surrounding line 510 is allocated to a cluster for “closed area” in the list box 601, and the marker area 512 and the marker area 513 are allocated to a cluster for “marker part” in the list box 602. Thus, with respect to the document image 500, among clusters which the engineer or user has preliminarily prepared, only two clusters are applicable.

Therefore, the information processing system 100 presents, to the user who uses the information processing system 100, “closed area” in the list box 601 and “marker part” in the list box 602 as options of a notation indicating an instruction portion directed to generative AI.

Furthermore, in the eighth exemplary embodiment, when indicating options of a notation indicating an instruction portion directed to generative AI, the information processing system 100 displays the options by text, but can display the options by an image of handwritten depiction portion representing an area. For example, instead of text “closed area (surrounding, etc.)” in the list box 601, the information processing system 100 depicts an image obtained by reducing and conceptualizing the surrounding line 510.

Moreover, in the eighth exemplary embodiment, the user who uses the information processing system 100 issues an instruction for an instruction portion directed to generative AI by selecting or pressing the list boxes 601 and 602. However, for example, the user who uses the information processing system 100 can issue an instruction for an instruction portion directed to generative AI by selecting or pressing handwritten depiction portions each representing an area (the surrounding line 510 and the marker areas 512 and 513) on the document image 500 in the screen 1700.

Upon detecting selection or pressing of handwritten depiction portions each representing an area by the user, the information processing system 100 reflects the selection result in the list boxes 601 and 602. Thus, for example, upon detecting pressing of the surrounding line 510, the information processing system 100 selects the list box 601.

Moreover, upon detecting selection or pressing of handwritten depiction portions each representing an area by the user, the information processing system 100 can perform intensified displaying, by, for example, highlighting, of the selected or pressed depiction portions.

As described above, according to the eighth exemplary embodiment, the information processing system 100 is able to present, to the user, only portions included in the received document image as options of instruction portions directed to generative AI. This enables reducing the user’s trouble in selecting an instruction portion.

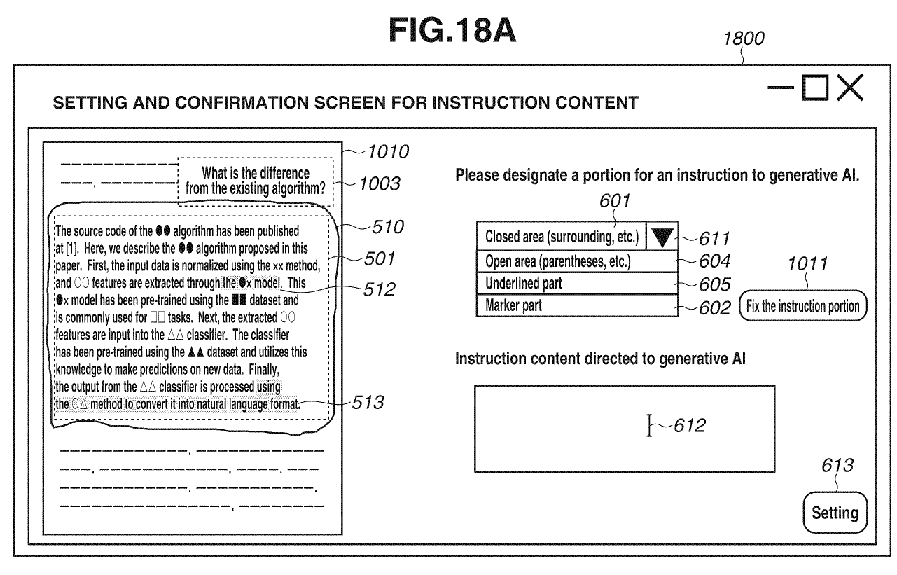

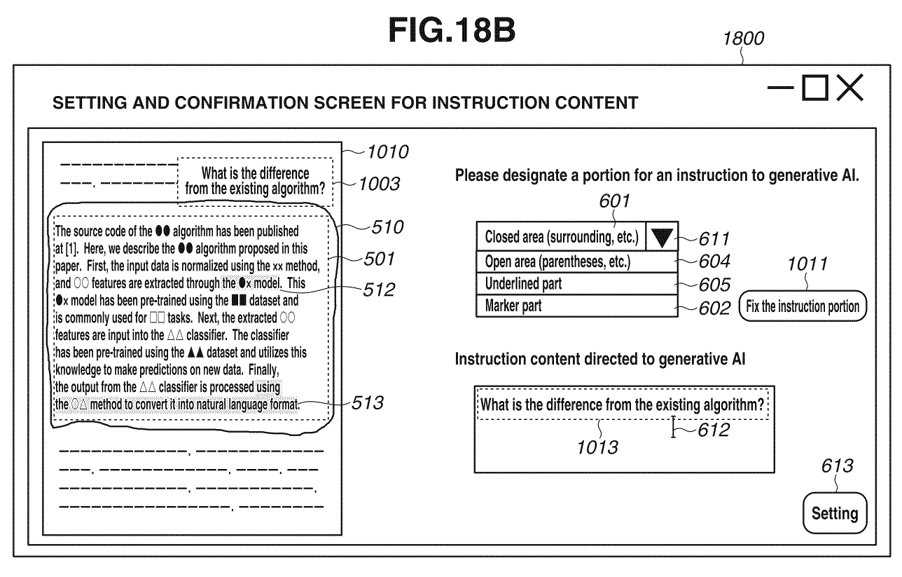

In the above-described sixth exemplary embodiment, the user who uses the information processing system 100 needs to input or designate an instruction sentence directed to generative AI in some way. On the other hand, in a ninth exemplary embodiment, in a case where there is a handwritten comment near an instruction portion directed to generative AI in a document image, the handwritten comment is reflected in an instruction sentence. The ninth exemplary embodiment is described with FIGS. 18A and 18B substituted for FIG. 14A used in the sixth exemplary embodiment and a document image 1010 illustrated in FIGS. 18A and 18B substituted for the document image 500 illustrated in FIG. 5A. In the ninth exemplary embodiment, points other than these are similar to those in the sixth exemplary embodiment and are, therefore, omitted from description here.

### Interface with User concerning Instruction to Generative AI

Each of FIGS. 18A and 18B is a diagram illustrating an example of a screen which is used for the user to perform setting and confirmation of an instruction content, on the display device 210 included in the information processing system 100 in the ninth exemplary embodiment. Among portions illustrated in each of FIGS. 18A and 18B, portions with the same reference numerals as those in FIG. 14A are similar to those in the sixth exemplary embodiment and are, therefore, omitted from description here.

The document image 1010 illustrated in FIG. 18A is an image obtained by adding a handwritten portion 1003 to the document image 500 illustrated in FIG. 5A. Moreover, a screen 1800 illustrated in FIG. 18B is a screen obtained by, in the screen 600 illustrated in FIG. 14A, substituting the document image 1010 for the document image 500 and substituting an instruction sentence 1013 for the instruction sentence 603.

When the user has pressed the list box 601 to select a notation indicating an instruction portion directed to generative AI and has then pressed an instruction portion confirmation button 1011, the information processing system 100 performs search processing for nearby handwritten characters with respect to the shape designated by the list box 601. The search processing is not illustrated, but can be performed as a processing operation in step S404 illustrated in FIG. 13.

As a specific example, the information processing system 100 searches for, among handwritten character strings located near the surrounding line 510 corresponding to “closed area” in the list box 601, a handwritten character string closest to the surrounding line 510. As the search method for nearby handwritten character strings, for example, the information processing system 100 calculates distances from a point on the surrounding line 510 to handwritten characters other than the “handwritten depiction portion representing an area”, and then selects a handwritten character string having the smallest distance. Thus, in the ninth exemplary embodiment, the information processing system 100 determines that a handwritten portion 1003 is an area applicable as a handwritten character string located near the surrounding line 510 and thus presents the handwritten portion 1003.

After that, the information processing system 100 performs OCR on the handwritten portion 1003 and thus acquires text 1013 as an OCR result. The information processing system 100 reflects the acquired text 1013 as an OCR result in an instruction sentence description field directed to generative AI illustrated in FIG. 18B. The reflected text 1013 can be modified by the user as with the sixth exemplary embodiment. Furthermore, in a case where no applicable handwritten portion is found near the surrounding line 510, the information processing system 100 operates in a manner similar to that in the sixth exemplary embodiment.

Moreover, the information processing system 100 can present, as nearby handwritten characters, all of the characters nearer than the distance from another “handwritten depiction portion representing an area or all of the characters existing within a specific threshold value. For example, without depending on nearness or not, the information processing system 100 can present all of the handwritten characters other than the “handwritten depiction portion representing an area” in the order of closeness to the surrounding line 510.

Moreover, while, in the ninth exemplary embodiment, the information processing system 100 performs OCR after searching for the nearest handwritten characters, the timing for performing OCR is not limited to this. Moreover, when searching for the nearest handwritten characters, the information processing system 100 can preliminarily perform narrowing down into handwritten portions with handwritten characters other than marks depicted therein.

As described above, according to the ninth exemplary embodiment, the information processing system 100 is able to present, to the user, a handwritten comment existing near an instruction portion directed to generative AI as an instruction sentence. This enables reducing the user’s trouble of inputting or modifying an instruction sentence.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151537 filed September 3, 2024, which is hereby incorporated by reference herein in its entirety.

What is claimed is:

1. A non-transitory computer-readable storage medium storing an application program which, when executed by one or more processors, causes an information processing apparatus to perform a control method, the control method comprising:
acquiring a document image including areas indicated by a plurality of handwritten portions on the document;
acquiring an instruction sentence input by a user;
identifying, from among the plurality of handwritten portions, an instruction portion that causes generative artificial intelligence (AI) to perform processing;
converting the acquired instruction sentence, which has been input by the user, into an instruction sentence enabling the generative AI to identify the instruction portion; and
outputting the instruction sentence obtained by conversion and the acquired document image to the generative AI.

2. The non-transitory computer-readable storage medium according to claim 1, wherein each of the plurality of handwritten portions includes any one or more of a portion surrounded by a line, a portion indicated by parentheses, an underlined portion, and a portion having a marker applied thereto.

3. The non-transitory computer-readable storage medium according to claim 1, wherein execution of the application program by the one or more processors, further causes the information processing apparatus to perform:
discriminating types of the plurality of handwritten portions;
accepting, from the user, selection of a type of each of the plurality of handwritten portions to be specified as the instruction portion; and
identifying, as the instruction portion, a handwritten portion corresponding to the type of handwritten portion the selection of which has been accepted.

4. The non-transitory computer-readable storage medium according to claim 1, wherein execution of the application program by the one or more processors, further causes the information processing apparatus to perform:
identifying a plurality of instruction portions each corresponding to the instruction portion; and
converting the acquired instruction sentence, which has been input by the user, into an instruction sentence enabling the generative AI to identify each of the plurality of instruction portions.

5. The non-transitory computer-readable storage medium according to claim 1, wherein execution of the application program by the one or more processors, further causes the information processing apparatus to perform:
searching for a handwritten character string closest to the instruction portion and causing a result of optical character recognition (OCR) performed on the handwritten character string to be included in an instruction sentence.

6. The non-transitory computer-readable storage medium according to claim 1, wherein the document image is acquired by scanning an original.

7. The non-transitory computer-readable storage medium according to claim 1, wherein execution of the application program by the one or more processors, further causes the information processing apparatus to perform:
causing a result of optical character recognition (OCR) performed on the document image to be included in an instruction sentence.

8. An information processing method comprising:
acquiring a document image including areas indicated by a plurality of handwritten portions on the document;
acquiring an instruction sentence input by a user;
identifying, from among the plurality of handwritten portions, an instruction portion that causes generative artificial intelligence (AI) to perform processing;
converting the acquired instruction sentence, which has been input by the user, into an instruction sentence enabling the generative AI to identify the instruction portion; and
outputting the instruction sentence obtained by conversion and the acquired document image to the generative AI.

9. The information processing method according to claim 8, wherein each of the plurality of handwritten portions includes any one or more of a portion surrounded by a line, a portion indicated by parentheses, an underlined portion, and a portion having a marker applied thereto.

10. The information processing method according to claim 8, further comprising:
discriminating types of the plurality of handwritten portions; accepting, from the user, selection of a type of each of the plurality of handwritten portions to be specified as the instruction portion; and identifying, as the instruction portion, a handwritten portion corresponding to the type of handwritten portion the selection of which has been accepted.

11. The information processing method according to claim 8, further comprising:
identifying a plurality of instruction portions each corresponding to the instruction portion; and
converting the acquired instruction sentence, which has been input by the user, into an instruction sentence enabling the generative AI to identify each of the plurality of instruction portions.

12. The information processing method according to claim 8, further comprising:
searching for a handwritten character string closest to the instruction portion and causing a result of optical character recognition (OCR) performed on the handwritten character string to be included in an instruction sentence.

13. The information processing method according to claim 8, wherein the document image is acquired by scanning an original.

14. The information processing method according to claim 8, further comprising:
causing a result of optical character recognition (OCR) performed on the document image to be included in an instruction sentence.

15. An information processing apparatus comprising at least one processor operating to:
acquire a document image including areas indicated by a plurality of handwritten portions on the document; acquire an instruction sentence input by a user;
identify, from among the plurality of handwritten portions, an instruction portion that causes generative artificial intelligence (AI) to perform processing;
convert the acquired instruction sentence, which has been input by the user, into an instruction sentence enabling the generative AI to identify the instruction portion; and
output the instruction sentence obtained by conversion and the acquired document image to the generative AI.
